(19) United States
(12) Patent Application Publication
(10) Pub. No.: US 2020/0377425 A1
(43) Pub. Date: Dec. 3, 2020

(54) LIGHTWEIGHT COMPOSITE MATERIALS

(71) Applicant: BORAL IP HOLDINGS (AUSTRALIA) PTY LIMITED, North Sydney (AU)

(72) Inventors: Amitabha KUMAR, San Antonio, TX (US); Cassandra HILL, San Antonio, TX (US); Li AI, San Antonio, TX (US); Russell HILL, San Antonio, TX (US)

(73) Assignee: BORAL IP HOLDINGS (AUSTRALIA) PTY LIMITED, North Sydney (AU)

(21) Appl. No.: 16/767,510

(22) PCT Filed: Nov. 28, 2017
(86) PCT No.: PCT/US2017/063391

§ 371 Date: May 27, 2020

(51) Int. Cl. C04B 41/50; C04B 41/00; C04B 41/65; C04B 28/02; C04B 18/02; C04B 14/18; C04B 14/24

(52) U.S. Cl. CPC C04B 41/5079; C04B 41/009; C04B 41/65; C04B 2111/00612; C04B 18/027; C04B 14/185; C04B 14/24; C04B 28/021

(57) ABSTRACT

Disclosed herein are composite materials, including composite building materials, comprising a polyurethane composite core in physical communication with a cementitious layer. Also disclosed are methods for producing the composite materials.

### TECHNICAL FIELD

The subject matter described herein relates generally to composite materials comprising a cementitious layer in physical communication with a polyurethane composite core. Also disclosed are methods for producing the composite materials.

### BACKGROUND

Certain properties are desired of composite materials that impart, among other things, durability, and resistance to weather, rot, water, and fire. To attain these properties, cementitious materials have been fabricated that can be used in place of natural materials, such as timber. There are, however, certain drawbacks with these materials. One such drawback is the higher density and weight of these materials, resulting in materials that are difficult to handle manually while being used in applications such as construction and also during operations of loading and unloading for transport. Furthermore, heavier materials are more burdensome to carry or transport, especially between places of manufacture and places of use, resulting in additional costs for the user.

Numerous attempts have been made to lower the weight in an effort to improve handling and transport characteristics of these cementitious materials. While fillers that lower the overall density can be used, the material has to be relatively thick and have the filler dispersed throughout the thickness of the material to achieve significant weight reduction. Accordingly, while a lighter product may be achieved, the physical and mechanical properties of the product can be compromised or the material must have a minimum bulk such that the result may be a measurable modification. In certain cases standard industry use dictates the physical dimensions of a material. As such, unilateral change of dimensions to achieve an attribute is not permissible.

Accordingly, there is a need for a lightweight material and method for manufacturing the same with improved handling and transport characteristics, durability, and wet to dry stability over that of typical products. The subject matter described herein addresses these needs.

### BRIEF SUMMARY

Aspects of the subject matter described herein include composite materials comprising a cementitious layer in physical communication with a polyurethane core and methods of making the composite materials.

A composite material comprises a cementitious layer comprising cement in an amount of greater than 60% by weight based on 100% by weight of the cementitious layer; and a polyurethane composite core having a first planar surface, the polyurethane composite core comprising fly ash in an amount of from 35% by weight to 80% by weight based on 100% by weight of the polyurethane composite core. The cementitious layer is in physical communication with the first planar surface.

In one aspect, the cement may be present in an amount of greater than or equal to 70% by weight based on 100% by weight of the cementitious layer. In another aspect, the cement may be present in an amount of greater than or equal to 80% by weight based on 100% by weight of the cementitious layer.

The cement may be selected from the group consisting of Portland cement, rapid-hardening cement, calcium aluminate cement, calcium sulfoaluminate cement, slag, other specialty type cement, a blend of cements, a blend of pozzolans, and combinations thereof. The Portland cement may be selected from the group consisting of Type I ordinary Portland cement (OPC), Type II OPC, Type III OPC, Type IV OPC, Type V OPC, low alkali Type I OPC, low alkali Type II OPC, low alkali Type III OPC, low alkali Type IV OPC, low alkali Type V OPC, and combinations thereof. In one aspect, the cement may be selected from the group consisting of Portland cement, calcium sulfoaluminate cement, and combinations thereof. In another aspect, the cement may be a blend of Type I OPC and calcium sulfoaluminate cement and may be present in the cementitious layer in a ratio of Type I OPC to calcium sulfoaluminate cement of from 1:6 to 6:1.

The cementitious layer may have a thickness of less than or equal to 25 mm.

The composite material may further comprise a plurality of cementitious layers, wherein a first cementitious layer is in physical communication with the first planar surface and a second cementitious layer is in physical communication with the first cementitious layer.

In one aspect, the polyurethane composite core may be foamed. The polyurethane composite core may be a reaction product of at least one polyol and at least one isocyanate in the presence of the fly ash, wherein the at least one isocyanate may be selected from the group consisting of diisocyanates, polyisocyanates, and combinations thereof.

The fly ash may be present in an amount of from 40% by weight to 60% by weight based on 100% by weight of the polyurethane composite core. In another aspect, the fly ash may be present in an amount of greater than or equal to 50% by weight based on 100% by weight of the polyurethane composite core.

The fly ash may be Class C fly ash or Class F fly ash. In one aspect, the fly ash is Class C fly ash.

In a further aspect, the polyurethane composite core may further comprise at least one of a filler and an additive. The polyurethane composite core may have a thickness of from 5 mm to 250 mm. The cementitious layer may be directly attached to the polyurethane composite core without the use of an adhesive.

The cementitious layer may be present in an amount of from 10% by weight to 60% by weight based on 100% of the composite material, and the polyurethane composite core may be present in an amount of from 40% by weight to 90% by weight based on 100% of the composite material.

In an additional aspect, the composite material may further comprise a lightweight aggregate. The cementitious layer may define a plurality of entrained pores therein that are water absorptive, and the lightweight aggregate may be disposed in the plurality of entrained pores. Two or more of the plurality of entrained pores may interconnect to form a network.

The lightweight aggregate may be selected from the group consisting of natural mineral perlite, expanded perlite, hollow glass beads, foamed glass beads, ground silica sandwiching, amorphous silica, diatomaceous earth, rice hull ash, blast furnace slag, granulated slag, steel slag, mineral oxides, mineral hydroxides, clays, magnasite, dolomite, layeric beads, volcanic tuff, pumice, ground tire rubber, metal oxides and hydroxides, and combinations thereof. In one aspect, the lightweight aggregate may be selected from the group consisting of expanded natural mineral perlite and foamed glass beads.

The lightweight aggregate may be present in an amount of from 0.1% by weight to 30% by weight based on 100% by weight of the cementitious layer. In another aspect, the lightweight aggregate may be present in an amount of from 0.1% by weight to 10% by weight based on 100% by weight of the cementitious layer.

The composite material may not crack after greater than or equal to 50 freeze-thaw cycles in which water penetrates the plurality of entrained pores, is first frozen to and maintained at a temperature of −10° C. for 3 hours, and is subsequently thawed to and maintained at a temperature of 10° C. for 1 hour. Further, the polyurethane composite core may not crack for at least 24 hours at a temperature of from 50° C. to 100° C.

The composite material may have a density of from 0.16 g/cm³ to 0.56 g/cm³. The composite material may have a flexural strength of from 2.07 MPa to 5.17 MPa. The composite material may have a modulus of from 413.69 MPa to 896.32 MPa.

In one aspect, the polyurethane composite core may further comprise a second planar surface and a second cementitious layer. The second cementitious layer may be in physical communication with the second planar surface. The cementitious layer and the second cementitious layer may be in physical communication and wrap around the polyurethane composite core to form a continuous cementitious layer that encapsulates the polyurethane composite core.

In another aspect, the polyurethane composite core may have a three-dimensional, engineered shape prepared from a mold. The three-dimensional, engineered shape may be selected from the group consisting of synthetic stone, roofing tiles, ceramic tiles, architectural stone, thin bricks, backer boards, bricks, pavers, sheets, panels, boards, underlays, banisters, lintels, pipes, posts, signs, guard rails, retaining walls, park benches, tables, railroad ties, and combinations thereof.

In one aspect, the three-dimensional, engineered shape may be a panel comprising the first planar surface and a second planar surface disposed opposite the first planar surface. The panel may be rectangular. The panel may have a width of 91.44 cm, a length of 152.40 cm, a thickness of less than or equal to 2.54 cm, and a weight of less than or equal to 13.61 kg.

A composite material comprises a cementitious layer comprising cement in an amount of from 60% by weight to 80% by weight based on 100% of the cementitious layer. The cement is a blend of Portland cement, Type I and Portland cement, Type III and is present in a ratio of Portland cement, Type I to Portland cement, Type III of from 1:5 to 5:1. The cementitious layer defines a plurality of entrained pores. The composite material also comprises lightweight aggregate disposed in the plurality of entrained pores. The lightweight aggregate is selected from the group consisting of foamed glass beads, natural mineral perlite, and combinations thereof and is present in an amount of from 0.1% by weight to 10% by weight based on 100% by weight of the cementitious layer. The composite material also comprises a polyurethane composite core or a foamed polyurethane composite core having a first planar surface and a second planar surface disposed opposite the first planar surface. The polyurethane composite core or the foamed polyurethane composite core comprises Class C fly ash present in an amount of from 40% by weight to 60% by weight based on 100% by weight of the polyurethane composite core or the foamed polyurethane composite core. The composite material has a density from 0.16 g/cm³ to 0.32 g/cm³. The cementitious layer and the polyurethane composite core or the foamed polyurethane composite core are in continuous physical communication at the first planar surface and the second planar surface without any adhesive therebetween. The composite material has a three-dimensional, engineered shape prepared from a mold, and the composite material does not contain a veil, scrim, or mesh.

In one aspect, the polyurethane composite core or the foamed polyurethane composite core may be essentially free of fibers.

In another aspect, the polyurethane composite core or the foamed polyurethane composite core may be a reaction product of at least one polyol and at least one isocyanate in the presence of the Class C fly ash. The at least one isocyanate may be selected from the group consisting of diisocyanates, polyisocyanates, and combinations thereof.

A composite material comprises a cementitious layer comprising cement in an amount of from 60% by weight to 80% by weight based on 100% by weight of the cementitious layer. The cementitious layer also comprises foamed glass beads in an amount of from 5% by weight to 10% by weight based on 100% by weight of the cementitious layer. The cement comprises Portland cement, Type I. The cementitious layer defines a plurality of entrained pores, and the foamed glass beads are disposed within the plurality of entrained pores. The composite material further comprises a polyurethane composite core or a foamed polyurethane composite core having a first planar surface and a second planar surface disposed opposite the first planar surface. The polyurethane composite core or the foamed polyurethane composite core comprises Class C fly ash present in an amount of from 40% by weight to 60% by weight based on 100% by weight of the polyurethane composite core or the foamed polyurethane composite core. The polyurethane composite core or the foamed polyurethane composite core is a reaction product of at least one polyol and at least one isocyanate in the presence of the Class C fly ash. The at least one isocyanate is selected from the group consisting of diisocyanates, polyisocyanates, and combinations thereof. The cementitious layer and the polyurethane composite core or the foamed polyurethane composite core are in continuous physical communication at the first planar surface and the second planar surface without any adhesive therebetween. The composite material is a three-dimensional, engineered panel prepared from a mold. The composite material does not contain a veil, scrim, or mesh and the polyurethane composite core or the foamed polyurethane composite core is essentially free of fibers.

In one aspect, the cement may further comprise Portland cement, Type III. The Portland cement, Type I and the Portland cement, Type III may be present in a ratio of Portland cement, Type I to Portland cement, Type III of from 1:5 to 5:1. In another aspect, the foamed glass beads may be present in an amount of less than or equal to 7% by weight based on 100% by weight of the cementitious layer.

A composite material comprises a cementitious layer comprising cement in an amount of from 60% by weight to 80% by weight based on 100% by weight of the cementitious layer, and expanded perlite in an amount of from 0.1% by weight to 5% by weight based on 100% by weight of the cementitious layer. The cement comprises Portland cement, Type I. The cementitious layer defines a plurality of entrained pores, and the expanded perlite is disposed in the plurality of entrained pores. The composite material further comprises a polyurethane composite core or a foamed polyurethane composite core having a first planar surface and a second planar surface disposed opposite the first planar surface. The polyurethane composite core or the foamed polyurethane composite core comprises Class C fly ash present in an amount of from 40% by weight to 60% by weight based on 100% by weight of the polyurethane composite core or the foamed polyurethane composite core. The polyurethane composite core or the foamed polyurethane composite core is a reaction product of at least one polyol and at least one isocyanate selected from the group consisting of diisocyanates, polyisocyanates, and combinations thereof in the presence of the Class C fly ash. The cementitious layer and the polyurethane composite core or the foamed polyurethane composite core are in continuous physical communication at the first planar surface and the second planar surface without any adhesive therebetween. The composite material is a three-dimensional, engineered panel prepared from a mold. The composite material does not contain a veil, scrim, or mesh, and the polyurethane composite core or the foamed polyurethane composite core is essentially free of fibers.

In one aspect, the cement may further comprise calcium sulfoaluminate cement, and the Portland cement, Type I and the calcium sulfoaluminate cement may be present in a ratio of Portland cement, Type I to calcium sulfoaluminate cement of from 1:5 to 5:1.

In another aspect, the expanded perlite may be present in an amount of 0.7% by weight based on 100% by weight of the cementitious layer.

A method of producing a building material formed from the composite material is also disclosed. The method comprises contacting the polyurethane composite core with the cementitious layer, and curing the cementitious layer to dispose the cementitious layer in physical communication with the polyurethane composite core without disposing an adhesive between the cementitious layer and the polyurethane composite core.

The method may further comprise preparing the cementitious layer by admixing lightweight aggregate with a mixture comprising the cement and water. Admixing may comprise high-shear mixing the cement and water to form the mixture, and, after high-shear mixing, low-shear mixing the lightweight aggregate and the mixture to form the cementitious layer.

In one aspect, the lightweight aggregate may be selected from the group consisting of natural mineral perlite and foamed glass beads. The lightweight aggregate may be present in an amount of from 2% by weight to 30% by weight based on 100% by weight of the cementitious layer.

The method may further comprise, prior to contacting, providing the polyurethane composite core and shaping at least the first planar surface.

In another aspect, the polyurethane composite core may have a second planar surface disposed opposite the first planar surface. The method may further comprise, prior to contacting, providing the polyurethane composite core; and shaping the first planar surface and the second planar surface. Contacting may include disposing the cementitious layer on the first planar surface and the second planar surface. Curing may include forming a continuous cementitious layer in physical communication with the first planar surface and the second planar surface.

These and other aspects of the subject matter described herein are disclosed in more detail in the description of the subject matter given below.

### BRIEF DESCRIPTION OF THE FIGURES

FIG. 1 depicts a foamed polyurethane composite core sandwich configuration having a polyurethane composite core and a cementitious layer disposed on opposing planar surfaces of the polyurethane composite core.

FIG. 2 depicts a cross-section comparison of a cementitious layer defining an entrained air void and a cementitious layer defining an entrained pore, wherein lightweight aggregate is disposed in the entrained pore.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims.

Cementitious building materials have been described where the material is of a consistent composition throughout. See, e.g., U.S. Pat. No. 8,182,606. That is, the building material is made up entirely of the cementitious material. These materials have been engineered for structural properties provided by the dispersion of the cementitious materials throughout the material. These products composed entirely of cementitious material would be expected to have the same or similar properties throughout the product. One of the properties of these materials is a relatively high density and accompanying weight. This makes handling the material more difficult and burdensome.

While use of a lightweight filler can lower density in these products, it would be expected to negatively impact the desired structural properties, or the lightweight filler would need to be dispersed throughout the entire material to significantly impact density and overall weight. Additionally, the addition of lightweight additives to a cementitious mixture can increase water expansion of the finished cement, which can cause durability problems.

As described herein, it has been found that a thin cementitious layer or a thin cementitious coating (comprised of several cementitious layers), as compared to the thickness of a polyurethane composite core, can be prepared that provides desired structural and flexural properties while improving freeze/thaw durability, improving heat and cold tolerance, and improving weather-resistance when layered onto the polyurethane composite core to prepare a composite material. Other properties discussed herein include unexpected modulation of flexural strength and modulus relationships.

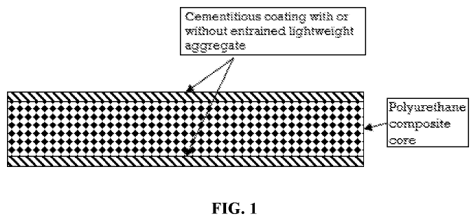

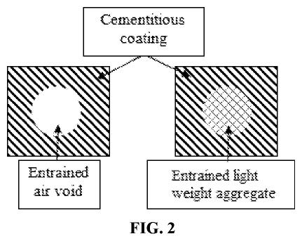

A layered product would be expected to have different properties because of its layered arrangement compared to a bulk material. Overcoming the absence of bulk cementitious material in the product therefore requires particular composite formulating to arrive at a product that has the desired features without loss of essential structural properties. Such products are described herein. FIG. 1 depicts an embodiment having a polyurethane composite core, which is sandwiched between two cementitious layers. FIG. 2 depicts a comparison between a cementitious layer defining an entrained air void and a cementitious layer defining a plurality of entrained pores, wherein lightweight aggregate is disposed in the plurality of entrained pores. These lightweight aggregates provide vacuous interiors, supported internally by thin, stiff struts. This morphology provides free space into which water can expand as it freezes into ice crystals, as well as structural support for surrounding cement. While air-entraining agents have been used in cement and concrete materials to introduce air-filled voids in an attempt to improve cold weather durability, it has been found that the composite materials described herein have desirable durability without the use of air-entraining or when the plurality of entrained pores have lightweight aggregate disposed therein.

In embodiments wherein the cementitious layer comprises entrained pores having lightweight aggregates disposed therein, the composite materials exhibit excellent stability during freeze/thaw cycles. Thus, weather-resistance is excellent. Other properties of the composite materials described herein include desirable flexural and tensile properties, rigidity, toughness, hardness, optical appearance, water resistance, resilience in the presence of electromagnetic radiation, and other chemical and physical attributes, while still providing desirable density and weight of the composite materials.

The composite materials can be used for application as structural or non-structural products. Specific uses of the composite materials can include applications as interior and exterior cladding on buildings, backer boards, and the like. The composite materials are desirable for such applications because they are relatively light in weight while maintaining the desired properties mentioned above. Yet another desired feature of the composite materials described herein is the relative ease of use as compared to cementitious materials or other natural and synthetic building materials.

### I. Definitions

As used herein, the term “composite material” or “composite building material” refers to a layered material comprising a polyurethane composite core and at least one cementitious layer.

The term “polyurethane composite core” refers to a core material at least partially comprising a polyurethane component in physical communication with the cementitious layer. The polyurethane composite core may comprise polyurethane in an amount of from 20% by weight to 60% by weight and other components in an amount of from 40% by weight to 80% by weight based on 100% by weight of the polyurethane composite core. These components are described elsewhere herein. In certain embodiments, the polyurethane composite core may be essentially fiber-free, by which is meant that the polyurethane composite core either does not contain a fiber component or any fiber present is in trace amounts, such as, less than 2% by weight, less than 1% by weight, less than 0.5% by weight, less than 0.1% by weight, or 0.0% by weight of the polyurethane composite core.

The term “cementitious layer” refers to a layer comprising a cured cement. The term “cementitious coating” refers to a coating comprising one or more cementitious layers. As used herein, cementitious and cement are distinguishable from concrete, the latter of which will contain gravel and/or coarse crushed stone and can contain minor amounts of cement. That is, the composite materials described herein do not include a concrete layer.

The term “physical communication” refers to one or more physical points of contact. The cementitious layer(s) and the polyurethane composite core can be in contact by binding or attaching to one another or can simply be adjacent and in physical contact with each other. The lightweight aggregates can be in physical communication with the cementitious layers and the plurality of entrained pores. In embodiments, the physical communication of the polyurethane composite core and the cementitious layer or of one cementitious layer to an adjacent cementitious layer will involve a large portion or essentially all of the available surface area. Advantageously, the cementitious layer and the polyurethane composite core adhere or attach to one another without the use of an additional adhesive, i.e., the cementitious layer and the polyurethane composite core are in direct contact with each other.

As used herein, the term “entrained pore” refers to a void or cell defined by the cured cementitious layer having lightweight aggregate contained therein. As used herein, the term “lightweight aggregate” refers to a material added to the cementitious layer which has a lower density than the cement component, has structural properties, and allows for the entrained pore to function as set forth herein. Entrained pores can interconnect with other entrained pores to form a network or continua. The lightweight aggregate can be in physical communication with the cementitious layer, other lightweight aggregate, or both. In embodiments, the lightweight aggregate can be situated such that physical communication of the lightweight aggregate material and the cementitious layer forms struts within the entrained pores. As used herein, the term “strut” refers to solid lightweight aggregate material within the entrained pore that forms structural support for the edges, faces, or interface of the entrained pores with the cementitious layer. The struts provide space to imbibe air, moisture, water and/or ice within the entrained pore. A “network” refers to a plurality of entrained pores physically interconnected. The network can accommodate and facilitate air, moisture, and water movement without causing deleterious effect on the cementitious layer, such as brittleness, cracking, fissure formation, and the like.

The term “water absorptive” refers to the ability to accommodate or collect water or moisture and allow air, moisture, and water movement. For instance, water, moisture, and air can passively migrate to, into, or through the entrained pores. Any ice formation can be contained predominantly within the entrained pores, reducing stress on the cementitious layer and substantially increasing the weather-resistance and thermal stability of the composite material.

As used herein, “freeze-thaw” refers to water penetration into a material followed by a freezing cycle and a thaw cycle. Water that has penetrated the composite material can freeze, and thus expand as an ice crystal forms, which places stress within the cementitious layer. This cycle can lead common products to failure by compromising the cement, resulting in deterioration, cracking, peeling, separating, etc.

As used herein, “weather-resistance” and like terms refer to the property of the composite materials to withstand the negative impact of natural conditions, rain, wind, hail, radiation, temperature fluctuations, moisture and humidity, and other weathering. As described herein, the weather-resistance of the composite materials described herein can be increased by 5%, 10%, 15%, 20%, 25%, 30%, 35%, 40%, 45%, 50%, 55%, 60%, 65%, 70%, 75%, 80%, 85%, 90%, 95%, 100%, or more, as compared to common building products. Assays can determine the weather-resistance of the composite materials.

As used herein, the term “heat tolerant” or “heat tolerance” refers to a property of the composite material to resist deleterious effects at elevated temperatures. In embodiments, the heat tolerant composite materials exhibit a heat tolerance increase of 5° C., 10° C., 20° C., 30° C., 40° C., 50° C., or more, as compared to other building or composite materials. As used herein, “resist cracking” refers to a property of the composite material not to develop cracks visible to the eye under test conditions. Additionally, there may no visible evidence that the cementitious layer and the polyurethane composite core are separating from each other.

An “engineered shape” refers to a configuration of the composite material that is formed by the processes described herein.

As used herein, the term “planar surface” refers to a surface that is a substantially flat plane. While the planar surface is substantially flat, there can be present certain defects, such as pits or other surface irregularities.

As used herein, the term “contacting” refers to a process where two or more components are allowed to be in such proximity that they are in physical communication.

As used herein, the term “plurality” refers to two or more.

As used herein, “workability” refers to ease of handling by workers, ability to set nails and screws, ease of scoring and cutting, etc.

Additional definitions may be provided elsewhere herein.

### II. Composite Materials

The subject matter described herein is directed to composite materials, e.g., composite building materials, and methods for their preparation. In an embodiment, the composite material comprises a cementitious layer in physical communication, for example, attached or adhered to, with a polyurethane composite core, wherein the polyurethane composite core is formed by the reaction of at least one isocyanate (such as diisocyanates and polyisocyanates), and at least one polyol in the presence of fly ash. The improved properties of the composite materials described herein as compared to other building materials, composites, or bulk cementitious materials can include, but are not limited to: lighter in weight with no significant loss in desirable mechanical properties; enhanced workability; enhanced freeze-thaw, heat tolerance, weather-resistance properties, density to flexural relationship, and density to modulus relationship. Further, the relatively light weight of the composite materials and composite building materials require less fuel to transport, and are also advantageous to those who handle and work with the composite materials by hand.

In an embodiment, the subject matter described herein is directed to a composite material comprising a cementitious layer comprising cement in an amount of greater than or equal to 60% by weight based on 100% by weight of the cementitious layer; and a polyurethane composite core having a first planar surface. The polyurethane composite core comprises fly ash in an amount of from 35% by weight to 80% by weight based on 100% by weight of the polyurethane composite core. The cementitious layer is in physical communication with the first planar surface. A representative structure is depicted in FIG. 1.

In certain embodiments, the polyurethane composite core is formed from a polyurethane. As described elsewhere herein, the polyurethane can be formed by the reaction of an isocyanate (such as diisocyanates and polyisocyanates), a polyol, and fly ash. In embodiments, the polyurethane composite core is a resinous, foamed core, e.g., those described in WO 2016/195717; U.S. Pat. No. 7,879,144; U.S. 2014/0349104; U.S. 2010/0292397, each of which is incorporated herein by reference in its entirety. In an embodiment, the polyurethane is based on a polyether or polyester based polyol and a diisocyanates or polyisocyanates that include methylene diphenyl diisocyanate (MDI), polymeric diphenylmethane diisocyanate (PMDI), toluene diisocyanate (TDI), or alkyl isocyanates. The polyol can contain an aromatic content and can incorporate a Mannich derived polyol(s). Polyurethane or polyurea or polyisocyanate products are suitable.

An exemplary foam polyurethane composite core is comprised of a highly filled rigid polyurethane foam. The foam can be prepared by combining approximately equal amounts of MDI and polyol. The formula ratio can be biased in order to produce an under or over indexed polyurethane foam. The polyurethane composite core can comprise fly ash in an amount of from 35% by weight to 80% by weight based on 100% by weight of the polyurethane composite core, or fly ash present in an amount of from 40% by weight to 60% by weight based on 100% by weight of the polyurethane composite core, or in an amount of 50% by weight based on 100% by weight of the polyurethane composite core. The polyurethane composite core can contain other fillers described elsewhere herein, such as, calcium carbonate, talc, etc. In addition to these three components, to prepare the foamed polyurethane composite core, a material is added to produce a gas which is trapped in the polyurethane which serves to lower the density. This material can be water which reacts with MDI to produce carbon dioxide, or a low boiling point-high vapor pressure solvent/refrigerant that is a gas at the processing temperature of the polyurethane. Several mixing technologies are compatible with this system and the selection of the mixing technology is dependent on the whether a continuous or non-continuous process is desired as well as the process rate.

The polyurethane composite core may have a thickness of from 5 mm to 250 mm. In some embodiments, the polyurethane composite core may have a thickness of from 10 mm to 200 mm, from 15 mm to 150 mm, from 20 mm to 100 mm, or from 25 mm to 50 mm. The polyurethane composite core may have a thickness of from 5 mm or more up to 250 mm, for example, 10 mm or more, 15 mm or more, 20 mm or more, 25 mm or more, 30 mm or more, 35 mm or more, 40 mm or more, 45 mm or more, 50 mm or more, 100 mm or more, 150 mm or more, or 200 mm or more.

The polyurethane composite core may have a three-dimensional, engineered shape prepared from a mold. In embodiments, the polyurethane composite core may be molded from a master mold. A cavity defined by the master mold can have any shape desired. Useful molds are those that are amenable to top-down filling. The polyurethane composite core prepared from such a mold may mimic the shape of the cavity of the mold. The molding may occur for a set time, which may be determined and adjusted and may depend on the chemistry of the polyurethane. After molding for a set time, the polyurethane composite core may have the desired thickness and planarity for coating, or the polyurethane composite core can further be shaped prior to coating by machining, slicing, cutting, sanding, planing, trimming, and the like to prepare a three-dimensional object having the desired engineered shape. The polyurethane composite core can be a generally solid monolith that is free of through holes.

Once coated with the cementitious layer, which is relatively thin compared to the polyurethane composite core, the overall shape of the composite material may essentially conform to the shape of the polyurethane composite core. A surface of the composite material may have designs, contours, and patterns, such as grains that mimic wood or other natural products. The surface can also be embossed. The three-dimensional, engineered shape may be selected from the group consisting of synthetic stone, roofing tiles (e.g., shake and slate tile), ceramic tiles, architectural stone, thin bricks, backer boards, bricks, pavers, sheets, panels, boards, underlays (e.g., bathroom underlay), banisters, lintels, pipes, posts, signs, guard rails, retaining walls, park benches, tables, railroad ties, other shaped articles, and combinations thereof. Shapes may include panels that resemble stucco, cement, stone, or brick. Particular shapes may include sheets, boards (e.g., backer boards), and blocks.

The three-dimensional, engineered shape may be a panel comprising the first planar surface and a second planar surface disposed opposite the first planar surface. In an embodiment, the panel may be rectangular. For example, the three-dimensional, engineered shape may be a panel 15.24 cm or 3 ft. by 152.4 cm or 5 ft. and up to 2.54 cm or 1 inch in thickness. In an embodiment, the shape of the composite material is a panel and the thickness is from 0.3175 cm or ⅛ in. to 1.5875 cm or ⅝ in, or from 0.3175 cm or ⅛ in. to 1.27 cm or ½ in., or from 0.3175 cm or ⅛ in. to 0.9525 cm or ⅜ in., or 0.635 cm or ¼ in. In one embodiment, the panel may have a width of 91.44 cm, a length of 152.40 cm, a thickness of less than or equal to 2.54 cm, and a weight of less than or equal to 13.61 kg. In embodiments, the thickness of the polyurethane composite core relative to the thickness of the entire cementitious layer is 100:1; or 80:1; or 60:1; or 40:1; or 20:1; or 10:1; or 9:1; or 8:1; or 7:1; or 6:1; or 5:1; or 4:1; or 3:1; or 2:1, or 1:1. In an embodiment, the composite material is a rectangular panel 0.635 cm or ¼ in. thick, where the polyurethane composite core is 0.381 cm or 0.15 in., and the polyurethane composite core is coated on each side with a cementitious layer that is 0.127 cm or 0.05 in. thick on each side.

In embodiments, the density of the composite material is 0.64 g/cm³ or 40 pcf or less, for example, the density of the composite material is below 0.56 g/cm³ or 35 pcf, or the density of the composite material is below 0.48 g/cm³ or 30 pcf, or the density of the composite material is below 0.40 g/cm³ or 25 pcf, or the density of the composite material is below 0.32 g/cm³ or 20 pcf, or the density of the composite material is below 0.24 g/cm³ or 15 pcf. In embodiments, the density is from 0.16 g/cm³ or 10 pcf to 0.56 g/cm³ or 35 pcf or from 0.27 g/cm³ or 17 pcf to 0.34 g/cm³ or 21 pcf. In one embodiment, the composite material may have a density of from 0.16 g/cm³ to 0.56 g/cm³.

As discussed above, in embodiments, the polyurethane composite core can be a foamed polyurethane composite core. That is, the polyurethane composite core may be foamed. Foaming agents and blowing agents may be added to the composite materials described herein to produce a foamed version of the composite materials. Examples of blowing agents may include organic blowing agents, such as halogenated hydrocarbons, acetone, hexanes, and other materials that have a boiling point below the reaction temperature. Chemical foaming agents include azodicarbonamides, and other materials that react at the reaction temperature to form gases such as carbon dioxide. Water is an exemplary foaming agent that reacts with isocyanate to yield carbon dioxide. The presence of water as an added component or in the filler also can result in the formation of polyurea bonds through the reaction of the water and isocyanate. In some embodiments, water may be present in the mixture used to produce the polyurethane composite core in an amount of from greater than 0% by weight to less than 5% by weight, based on 100% by weight of the mixture. In some embodiments, water can be present in a range of 0.02% by weight to 4% by weight, 0.05% by weight to 3% by weight, 0.1% by weight to 2% by weight, or 0.2% by weight to 1% by weight, based on 100% by weight of the mixture. In some embodiments, the mixture used to produce the polyurethane composite core may include less than or equal to 0.5% by weight water.

In embodiments, the polyurethane composite core or foamed polyurethane composite core may be essentially free of fibers. In embodiments where fibers are present, the fibers selected can include those described in WO 2016/195717, incorporated herein by reference in its entirety. The fiber material or fibers can be present in the polyurethane composite core in an amount of from 0.5% by weight to 20% by weight, based on 100% by weight of the polyurethane composite core. For example, the fiber material (when used) can be present in amounts of from 1% by weight to 10% by weight, from 1.5% by weight to 8% by weight, from 2% by weight to 6% by weight, or from 2% by weight to 4% by weight, based on 100% by weight of the polyurethane composite core. In some embodiments, a fiber material can be included in the polyurethane composite core, e.g., to provide increased strength, stiffness or toughness. The optimization of various properties of the composite material allows the use of the composite material in building materials and other structural applications. The fiber material can be any natural or synthetic fiber material, based on inorganic materials, organic materials, or combinations of both. Fiber materials suitable for use with the polyurethane composite core can be present in the form of individual fibers, fabrics, rovings, or tows. Exemplary fiber materials that can be used in the polyurethane composite core may include glass fibers and mineral wool fibers such as stone wool, slag wool, or ceramic fiber wool. The mineral wool fibers can be synthetic or can be obtained from molten mineral such as lava, rock, or stone. Other suitable inorganic fiber materials include basalt fibers, wollastonite fibers, alumina silica fibers, aluminum oxide fibers, silica fibers, carbon fibers, metal fibers, and combinations thereof. Exemplary organic fiber materials that can be used in the polyurethane composite may include hemp fibers, sisal fibers, cotton fibers, straw, reeds, or other grasses, jute, bagasse fibers, abaca fibers, flax, southern pine fibers, wood fibers, cellulose, saw dust, wood shavings, lint, vicose, leather fibers, rayon, and mixtures thereof. Other suitable organic fiber materials may include synthetic fibers such as Kevlar®, viscose fibers, polyamide fibers, polyacrylonitrile fibers, DRALON® fibers, polyethylene fibers, polypropylene fibers, polyvinyl alcohol fibers, polyacrylic fibers, polyester fibers, aramid fibers, carbon fibers, or combinations thereof. In some embodiments, the polyurethane composite core can include a combination of fibers that break and fibers that do not break when the composite material is fractured by external stress. Yet other fibers, such as specific glass fibers, are described elsewhere herein.

The polyurethane composite core may comprise at least one of a filler and an additive, e.g., additional fillers and/or additives. The polyurethane composite core can contain fillers as described elsewhere herein to modulate the properties of the polyurethane composite core as desired. Additional additives useful with the composite materials described herein may include fibers, surfactants, chain-extenders, crosslinkers, coupling agents, UV stabilizers, fire retardants, antimicrobials, antioxidants, and pigments.

The cementitious layer comprises the cement described above. The cement may be selected from the group consisting of Portland cement, rapid-hardening cement, calcium aluminate cement, calcium sulfoaluminate cement, slag, other specialty type cements, a blend of cements, a blend of pozzolans, and combinations thereof. For example, the cement may be selected from the group consisting of Portland cement, calcium sulfoaluminate cement, and combinations thereof. In one embodiment, the Portland cement may be selected from the group consisting of Type I ordinary Portland cement (OPC), Type II OPC, Type III OPC, Type IV OPC, Type V OPC, low alkali Type I OPC, low alkali Type II OPC, low alkali Type III OPC, low alkali Type IV OPC, low alkali Type V OPC, and combinations thereof. The Type (I-V) may be determined according to ASTM International standards.

In embodiments, the cement may be a blend of two or more different cements. In one aspect, the blend contains Portland cement and another cement from the group above. In an aspect, the blend contains Portland cement, Type I and another cement from the group above. In an aspect, the cement may be a blend of Type I OPC and calcium sulfoaluminate cement. In an aspect the Portland cement used contains Type I and II without a clear distinction to the exact Type, which is common to those with skill in the art. In embodiments where the blend contains two cements, the cements in the blend can be in relative ratios of from 99:1 to 1:99; 10:1 to 1:10; 5:1 to 1:5; 4:1 to 1:4; 3:1 to 1:3; 2:1 to 1:2; or 1:1. In embodiments, the cement of the cementitious layer may consist essentially of a two-cement blend. The two-cement blend may include Portland cement and calcium sulfoaluminate cement. The blend of Type I OPC and calcium sulfoaluminate may be present in the cementitious layer in a ratio of Type I OPC to calcium sulfoaluminate cement of from 1:6 to 6:1. In embodiments, the ratio is from 2:1 to 6:1. In embodiments, the ratio is from 3:1 to 5:1, or 4:1. The two-cement blend may include Portland cement, Type I and Portland cement, Type III. The cement may be a blend of Portland cement, Type I and Portland cement, Type III and may be present in a ratio of Portland cement, Type I to Portland cement, Type III of from 1:5 to 5:1.

In an embodiment, calcium aluminate cement (i.e., high aluminate cement) or calcium sulfoaluminate cement may be included in the cementitious layer. In some examples, the calcium aluminate cement or calcium sulfoaluminate cement may be present in an amount of from 1% by weight to 50% by weight; from 2% by weight to 40% by weight; from 3% by weight to 30% by weight; from 4% by weight to 20% by weight; or from 5% by weight to 10% by weight based on 100% by weight of the cementitious layer. In some embodiments, the calcium aluminate cement or calcium sulfoaluminate cement can be present in an amount of 50% by weight or less, 40% by weight or less, 30% by weight or less, 20% by weight or less, 15% by weight or less, 10% by weight or less, 5% by weight or less, 4% by weight or less, 3% by weight or less, or 2% by weight or less based on 100% by weight of the cementitious layer. In further embodiments, the calcium aluminate cement or calcium sulfoaluminate cement can be used in compositions that include less than 10% by weight hydrated or semi-hydrated forms of calcium sulfate (e.g., gypsum). In some embodiments, the cementitious layer is substantially free from calcium aluminate cement or includes no calcium aluminate cement. In some embodiments, the cementitious layer is substantially free from Portland cement or includes no Portland cement.

In an embodiment, pozzolans may also be included as a cementitious component in the cementitious layer. As used herein, the term “pozzolans” refers to siliceous or silico-aluminous materials that in themselves have little or no cementitious value but, in finely divided form and in the presence of moisture, chemically react with calcium hydroxide at ordinary temperature to generate compounds possessing cementitious properties. Non-limiting examples of pozzolans may include slags, volcanic or other ashes, pumicites, opaline cherts and shales, tufts, and some diatomaceous earths.

In one aspect, depending on the type of cementitious component used, the cementitious layer described herein can comprise cement in an amount of from 0.1% by weight to 99.9% by weight, from 0.1% by weight to 50% by weight, or from 0.1% by weight to 30% by weight, such as 0.1% by weight, 0.25% by weight, 0.5% by weight, 0.75% by weight, 1% by weight, 2% by weight, 5% by weight, 7% by weight, 10% by weight, 15% by weight, 20% by weight, 25% by weight, 30% by weight, 40% by weight, 45% by weight, 50% by weight, 55% by weight, 60% by weight, 65% by weight, 70% by weight, 75% by weight, 80% by weight, 85% by weight, 90% by weight or 95% by weight of each cementitious component used in the total weight of the cementitious layer, or any range between two of the numbers (end point inclusive).

In some embodiments, the total amount of cement (whether one single type of cement or the total of a blend of different cements) is present in an amount of greater than or equal to 60% by weight based on 100% by weight of the cementitious layer, an amount or greater than or equal to 70% by weight based on 100% by weight of the cementitious layer, or an amount of greater than or equal to 80% by weight based on 100% by weight of the cementitious layer, or in an amount greater than 90% by weight based on 100% by weight of the cementitious layer. For example, the total amount of cement may be present in an amount of greater than 85% by weight, greater than 90% by weight, or greater than 95% by weight based on 100% by weight of the cementitious layer. For example, the total amount of cement can be present in an amount of greater than 85% by weight, greater than 86% by weight, greater than 87% by weight, greater than 88% by weight, greater than 89% by weight, greater than 90% by weight, greater than 91% by weight, greater than 92% by weight, greater than 93% by weight, greater than 94% by weight, greater than 95% by weight, greater than 96% by weight, greater than 97% by weight, greater than 98% by weight, or greater than 99% by weight based on 100% by weight of the cementitious layer. The total amount of cement may be in the range of from 60% by weight to 97% by weight; from 65% by weight to 97% by weight; from 82% by weight to 97% by weight; from 85% by weight to 95% by weight; or from 87% by weight to 92% by weight based on 100% by weight of the cementitious layer.

The composite material may further comprise a lightweight aggregate. The cementitious layer may define a plurality of entrained pores therein that are water absorptive, and the lightweight aggregate may be disposed in the plurality of entrained pores. The inclusion of lightweight aggregates in the cementitious layer described herein can modify and/or improve the chemical and mechanical properties of the compositions and cementitious layer. The lightweight aggregates may be entrained in the cementitious layer within the entrained pores. In one embodiment, the lightweight aggregate can include natural mineral perlite, expanded perlite, foamed glass beads, and mixtures thereof. Median sizes of the lightweight aggregate can be from about 0.1 mm to about 0.5 mm, for example, from about 0.1 mm to about 0.3 mm, or from about 0.25 to about 0.5 mm. The lightweight aggregate may be selected from the group consisting of natural mineral perlite, expanded perlite, hollow glass beads, foamed glass beads, ground silica sand, amorphous silica, diatomaceous earth, rice hull ash, blast furnace slag, granulated slag, steel slag, mineral oxides, mineral hydroxides, clays, magnasite, dolomite, layeric beads, volcanic tuff, pumice, ground tire rubber, metal oxides and hydroxides, and combinations thereof. In one embodiment, the lightweight aggregate may be selected from the group consisting of expanded natural mineral perlite and foamed glass beads.

The lightweight aggregate may be present in an amount of from 0.1% by weight to 30% by weight based on 100% by weight of the cementitious layer. For example, the lightweight aggregate may be present in an amount of from 0.1% by weight to 10% by weight based on 100% by weight of the cementitious layer. The lightweight aggregate may be present in an amount in a range of from 0.01% by weight to 40% by weight; 0.01% by weight to 10% by weight; 0.01% by weight to 5% by weight; 0.01% by weight to 1.0% by weight; 0.1% by weight to 30% by weight; 1% by weight to 35% by weight; 1% by weight to 30% by weight; 1% by weight to 10% by weight; 2% by weight to 30% by weight; 3% by weight to 25% by weight; or 4% by weight to 20% by weight based on 100% by weight of the cementitious layer. The lightweight aggregate may be present in an amount in a range of from a minimum of 0.01% by weight to 40% by weight or less, 35% by weight or less, 30% by weight or less, 25% by weight or less, 20% by weight or less, 15% by weight or less, 10% by weight or less, or 5% by weight or less based on 100% by weight of the cementitious layer. For example, the composite can include 40% by weight or less, 39% by weight or less, 38% by weight or less, 37% by weight or less, 36% by weight or less, 35% by weight or less, 34% by weight or less, 33% by weight or less, 32% by weight or less, 31% by weight or less, 30% by weight or less, 29% by weight or less, 28% by weight or less, 27% by weight or less, 26% by weight or less, 25% by weight or less, 24% by weight or less, 23% by weight or less, 22% by weight or less, 21% by weight or less, 20% by weight or less, 19% by weight or less, 18% by weight or less, 17% by weight or less, 16% by weight or less, 15% by weight or less, 14% by weight or less, 13% by weight or less, 12% by weight or less, 11% by weight or less, 10% by weight or less, 9% by weight or less, 8% by weight or less, 7% by weight or less, 6% by weight or less, 5% by weight or less, 4% by weight or less, 3% by weight or less, 2% by weight or less, 1% by weight or less, or 0.5% by weight or less based on 100% by weight of the cementitious layer. When foamed glass beads are used, exemplary amounts may include from 2% by weight to 30% by weight, or from 5% by weight to 25% by weight, or from 5% by weight to 10% by weight, or 7% by weight based on 100% of the cementitious layer. The foamed glass beads may be present in an amount of less than or equal to 7% by weight based on 100% by weight of the cementitious layer. When expanded perlite is used, exemplary amounts may include from 0.01% by weight to 5% by weight, from 0.01% by weight to 1% by weight, or 0.7% by weight based on 100% by weight of the cementitious layer. The expanded perlite may be present in an amount of 0.7% by weight based on 100% by weight of the cementitious layer.

In embodiments, the addition of lightweight aggregates such as expanded perlite and foamed glass beads lowers density and improves overall workability properties while reducing the moisture expansion observed with that of low density additives.

In some embodiments, inorganic fibers or organic fibers can be included in the cementitious layers, e.g., to provide increased strength, stiffness, or toughness. In some examples, fire resistant or retardant glass fibers can be included to impart fire resistance or retarding properties to the cementitious layer. Fibers suitable for use with the cementitious layer described herein can be provided in the form of individual fibers, fabrics, rovings, or tows. These can be chopped and can be provided before or during the mixing of the cementitious layer. Non-limiting examples of fibers may include glass (e.g., chopped glass fibers, fiberglass veil, or fiberglass mat), layeric scrim, polyvinyl alcohol (PVA), carbon, basalt, wollastonite, and natural (e.g., bamboo or coconut) fibers. The fiber can also be, but is not limited to, cellulose wood pulp, ceramic fiber, glass fiber, mineral wool, steel fiber, and synthetic layer fibers such as polyamides, polyester, polypropylene, polymethylpentene, polyacrylonitrile, polyacrylamide, viscose, nylon, polyvinyl chloride (PVC), PVA, rayon, glass ceramic, carbon or any mixtures thereof. In an embodiment, more than one type of fiber may be used.

Examples of suitable fibers and methods of providing fibers in cementitious compositions are found, for example, in U.S. Pat. No. 5,108,679, which is herein incorporated by reference. The fibers can be included in an amount of from 0.1% by weight to 6% by weight based on 100% by weight of the cementitious layer. For example, the fibers can be included in an amount of from 0.5% by weight to 5% by weight, from 0.75% by weight to 4% by weight, or from 1% by weight to 3% by weight based on 100% by weight of the cementitious layer. In some embodiments, the fibers are provided in an amount of from 1% or less by weight, based on the weight of the cementitious layer including the lightweight aggregate.

Fibers may include glass fibers, such as E-glass, C-glass, S-glass, and AR-glass fibers. In some examples, fire resistant or retardant glass fibers can be included to impart fire resistance or retarding properties to the composites. The glass fibers can be from 1 mm to 50 mm in average length. In some examples, the glass fibers are from 1 mm to 20 mm, from 2 mm to 20 mm, from 3 mm to 20 mm, or from 3 mm to 15 mm in average length. In some examples, the average length of the glass fibers can be 1 mm or greater, 1.5 mm or greater, 2 mm or greater, 3 mm or greater, 4 mm or greater, 5 mm or greater, or 6 mm or greater. In some embodiments, the average length of the glass fibers can be 50 mm or less, 40 mm or less, 30 mm or less, 20 mm or less, 15 mm or less, 12 mm or less, or 10 mm or less. The glass fibers can be provided in a random orientation or can be axially oriented. The glass fibers can be coated with a sizing agent to modify their reactivity. The glass fibers can have any dimension of from 5 μm to 30 μm in average diameter. For example, the average diameter of the glass fibers can be from 5 μm to 25 μm, from 6 μm to 20 μm, from 5 μm to 18 μm, or from 5 μm to 15 μm in average diameter. In an embodiment, the fiber is fiberglass. In an embodiment, the fiber is chopped fiberglass. In an embodiment, the fiberglass has a sizing. In an embodiment, the fiberglass has a sizing comprising a silane. In a certain embodiment, the sizing comprises a mixture of starch and oil. The cementitious layers described herein do not require a scrim, veil, or the like. As such, the composite layers can be prepared without a scrim, veil, or the like.

The cementitious layers can comprise additional fillers and additives, some of which are described elsewhere herein.

The thickness of the cementitious layer can be varied to provide the desirable properties. The cementitious layer may generally have a thickness that is less than the thickness of the polyurethane composite core. The cementitious coating containing a plurality of cementitious layers may generally have a thickness that is less than the thickness of the polyurethane composite core. The cementitious layer or the cementitious coating comprising the plurality of cementitious layers may have a thickness of less than or equal to 25 mm. In embodiments, the thickness can range from about 20 mm to about 0.1 mm. In embodiments, the thickness may be from about 15 mm to about 0.3 mm. In embodiments, the thickness may be from about 9 mm to about 0.5 mm. In embodiments, the thickness may be from about 5 mm to about 1.0 mm. In embodiments, the thickness may be from about 3 mm to about 2 mm. The thickness of the cementitious layer or the cementitious coating comprising the plurality of cementitious layers can be less than 90% of the thickness of the core, less than 80% of the thickness of the core, less than 70% of the thickness of the core, less than 60% of the thickness of the core, less than 50% of the thickness of the core, less than 40% of the thickness of the core, less than 30% of the thickness of the core, less than 20% of the thickness of the core, less than 10% of the thickness of the core, or less than 5% of the thickness of the core.

The surface of the cementitious layer is not impacted by the presence of the entrained pores having lightweight aggregates disposed therein. The inner surface of the cementitious layer is highly compatible with the polyurethane composite core, such that an interaction, e.g., an attachment, physical interaction, chemical interaction, non-chemical interaction, or adherence without an adhesive, can be created that further provides for the desirable strength and durability of the composite materials. The outer surface has a desirable finish and is suitable for painting and aesthetic treatment, or the addition of further surfaces such a tile with a mortar bond.

The polyurethane composite core and the cementitious layer are in physical communication. In an embodiment, the polyurethane composite core and the cementitious layer can be attached directly to one another without the use of an adhesive or binding layer. In some embodiments, an adhesive can be used to bond the polyurethane composite core to the cementitious layer. Additional cementitious layers can be in physical communication with the cementitious layer that is in physical communication with the polyurethane core to form the cementitious coating comprising the plurality of cementitious layers. In other embodiments, the composite material may further comprise the plurality of cementitious layers, wherein a first cementitious layer is in physical communication with the first planar surface, and a second cementitious layer is in physical communication with the first cementitious layer.

Generally, the polyurethane composite core may have a density that is a fraction of the density of the cementitious layer. Thus, the relative densities of polyurethane composite core to cementitious layer may be from 1:1.5 to 1:45, or from 1:2 to 20, or from 1:3 to 1:5, or 1:4.

With respect to the relative weights of the components of the composite materials, in some embodiments, the polyurethane composite core may be present in an amount of from 40% by weight to 90% by weight based on 100% by weight of the composite material, and the cementitious layer may be present in an amount of from 10% by weight to 60% by weight based on 100% by weight of the composite material. In an embodiment, the composite material may comprise from 20% by weight to 50% by weight cementitious layer(s), and from 50% by weight to 80% by weight polyurethane composite core based on 100% by weight of the composite material. In an embodiment, the composite material may comprise from 20% by weight to 30% by weight cementitious layer(s), and from 70% by weight to 80% by weight polyurethane composite core based on 100% by weight of the composite material. For example, the composite material can include 60% by weight of the polyurethane composite core and 40% by weight of the cementitious layer(s) based on 100% by weight of the composite material; the composite material can include 70% by weight of the polyurethane composite core and 30% by weight of the cementitious layer(s) based on 100% by weight of the composite material; the composite material can include 80% by weight of the polyurethane composite core and 20% by weight of the cementitious layer(s) based on 100% by weight of the composite material; or can include 75% by weight of the polyurethane composite core and 25% by weight of the cementitious layer(s) based on 100% by weight of the composite material.

The composite material can include less than or equal to 60% by weight of the cementitious layer(s) with a minimum of 10% by weight based on 100% by weight of the composite material. In some embodiments, the composite material can include 50% by weight, or 40% by weight, or 30% by weight, or 20% by weight, or 15% by weight, or 10% by weight of the cementitious layer(s) based on 100% by weight of the composite material.

The composite material can include less than or equal to 90% by weight of the polyurethane composite core, with a minimum of 40% by weight. In some embodiments, the composite material can include 80% by weight, or 70% by weight, or 60% by weight, or 50% by weight, or 40% by weight of the polyurethane composite core based on 100% by weight of the composite material.

The at least one isocyanate may be selected from the group consisting of diisocyanates, polyisocyanates, and mixtures thereof. Isocyanates useful with the polyurethanes described herein may include one or more monomeric or oligomeric poly- or di-isocyanates. The monomeric or oligomeric poly- or di-isocyanate may include aromatic diisocyanates and polyisocyanates. The isocyanates can also be blocked isocyanates. An example of a useful diisocyanate is methylene diphenyl diisocyanate (MDI). Useful MDIs may include MDI monomers, MDI oligomers, and mixtures thereof. Further examples of useful isocyanates may include those having NCO (i.e., the reactive group of an isocyanate) contents ranging from 25% by weight to 35% by weight based on 100% by weight of the isocyanate. Examples of useful isocyanates may be found, for example, in Polyurethane Handbook: Chemistry, Raw Materials, Processing Application, Properties, 2^{nd} Edition, Ed: Gunter Oertel; Hanser/Gardner Publications, Inc., Cincinnati, Ohio, which is herein incorporated by reference. Suitable examples of aromatic polyisocyanates may include 2,4- or 2,6-toluene diisocyanate, including mixtures thereof; p-phenylene diisocyanate; tetramethylene and hexamethylene diisocyanates; 4,4-dicyclohexylmethane diisocyanate; isophorone diisocyanate; 4,4-phenylmethane diisocyanate; polymethylene polyphenylisocyanate; and mixtures thereof. In addition, triisocyanates may be used, for example, 4,4,4-triphenylmethane triisocyanate; 1,2,4-benzene triisocyanate; polymethylene polyphenyl polyisocyanate; methylene polyphenyl polyisocyanate; and mixtures thereof. Suitable blocked isocyanates may be formed by the treatment of the isocyanates described herein with a blocking agent (e.g., diethyl malonate, 3,5-dimethylpyrazole, methylethylketoxime, and caprolactam). Isocyanates are commercially available, for example, from Bayer Corporation (Pittsburgh, Pa.) under the trademarks MONDUR® and DESMODUR®. Other examples of suitable isocyanates may include MONDUR® MR Light (Bayer Corporation; Pittsburgh, Pa.), PAPI™ 27 (Dow Chemical Company; Midland, Mich.), Lupranate® M20 (BASF Corporation; Florham Park, N.J.), Lupranate® M70L (BASF Corporation; Florham Park, N.J.), Rubinate® M (Huntsman Polyurethanes; Geismar, La.), Econate 31 (Ecopur Industries), and derivatives thereof.

The average functionality of isocyanates or combinations of isocyanates may be from 1.5 to 5. Further, examples of useful isocyanates may include isocyanates having an average functionality of from 2 to 4.5, from 2.2 to 4, from 2.4 to 3.7, from 2.6 to 3.4, and from 2.8 to 3.2.

The polyol can include, for example, polyester polyols or polyether polyols. Polyols or combinations of polyols useful with the polyurethanes described herein may have an average functionality of from 1.5 to 8.0. Useful polyols may additionally have an average functionality of from 1.6 to 6.0, from 1.8 to 4.0, from 2.5 to 3.5, or from 2.6 to 3.1. The average hydroxyl number values for polyols useful with the polyurethanes described herein may include hydroxyl numbers from 100 to 600, from 150 to 550, from 200 to 500, from 250 to 440, from 300 to 415, and from 340 to 400.

In embodiments, the polyol may include one or more plant-based polyols. The use of plant-based polyols increases the environmental content of the composite materials. The one or more plant-based polyols can include castor oil. Castor oil is a commercially available material, and is described, for example, in Encyclopedia of Chemical Technology, Volume 5, John Wiley & Sons (1979). Suitable castor oils include those sold by Vertellus Specialities, Inc., e.g., DB® Oil, and Eagle Specialty Products, e.g., T31® Oil.

The one or more plant-based polyols described herein can include polyols containing ester groups that are derived from plant-based fats and oils. Accordingly, the one or more plant-based polyols can contain structural elements of fatty acids and fatty alcohols. Starting materials for the plant-based polyols of the polyurethane component may include fats and/or oils of plant-based origin with unsaturated fatty acid residues. The one or more plant-based polyols useful with the polyurethanes described herein can include, for example, castor oil; coconut oil; corn oil; cottonseed oil; lesquerella oil; linseed oil; olive oil; palm oil; palm kernel oil; peanut oil; sunflower oil; tall oil; and mixtures thereof. In some embodiments, the one or more plant-based polyols can be derived from soybean oil as the plant-based oil.

In some embodiments, the one or more polyols can include highly reactive polyols that include a large number of primary hydroxyl groups (e.g. 75% or more or 80% or more) as determined using fluorine nuclear magnetic resonance spectroscopy as described in ASTM D4273. In some embodiments, the highly reactive polyol can have a primary hydroxyl number, defined as the hydroxyl number multiplied by the percentage of primary hydroxyl groups based on the total number of hydroxyl groups, of greater than 250. Exemplary highly reactive polyols include plant-based polyols such as Pel-Soy 744 and Pel-Soy P-750, soybean oil based polyols commercially available from Pelron Corporation; Agrol Diamond®, a soybean oil based polyol commercially available from BioBased Technologies; Ecopol 122, Ecopol 131 and Ecopol 132, soybean oil polyols formed using polyethylene terephthalate and commercially available from Ecopur Industries; Honey Bee™ HB-530, a soybean oil-based polyol commerically available from MCPU Layer Engineering; Renewpol, a castor oil-based polyol commercially available from Styrotech Industries (Brooklyn Park, Minn.); JeffAdd® B 650, a 65% bio-based content (using ASTM D6866-06) additive based on soybean oil commercially available from Huntsman Polyurethanes (Auburn Hills, Mich.); Stepanpol® PD-110 LV and PS 2352, polyols based on soybean oil, diethylene glycol and phthalic anhydride and commercially available from Stepan Company; and derivatives thereof. In some embodiments, the highly reactive plant-based polyols can be formed by the reaction of a soybean oil and a polyester to produce a plant-based polyester polyol. An example of such a soybean oil-based polyester polyol is Ecopol 131, which is a highly reactive aromatic polyester polyol comprising 80% primary hydroxyl groups. Polyester polyols can be prepared using recyclable polyester to further increase the recyclable content of an organic layer and Ecopol 131 is an example of such a polyester polyol. In some embodiments, the soybean oil and polyester based polyol can be prepared using recycled polyester. In some embodiments, the polyol can include renewable and recyclable content.

The castor oil component when combined with a highly reactive polyol such as Ecopol 131 may also provide benefits such as increased resiliency, toughness, and handleability. The castor oil and highly reactive polyol can be combined in various percentages, e.g., 15%-40% of the castor oil and 60%-85% of the highly reactive polyol. The castor oil also can provide a polyurethane foam product that is harder to break and thus that can be used for more demanding applications.

The polyurethane composite core includes the fly ash. The polyurethane composite core may be a reaction product of at least one polyol and at least one isocyanate in the presence of the fly ash, e.g., Class C fly ash, resulting in a fly ash component of the polyurethane composite core. Fly ash is produced from the combustion of pulverized coal in electrical power generating plants. Fly ash produced by coal-fueled power plants is suitable for use in reactive powder described herein. The fly ash may be Class C fly ash or Class F fly ash. In one embodiment, the fly ash may be a mixture of Class C fly ash and Class F fly ash. In one embodiment, the fly ash may be Class C fly ash. As such, the calcium content of the fly ash can vary. In exemplary compositions, the fly ash can have a calcium content, expressed as the oxide form (i.e., calcium oxide), of from 18% by weight to 35% by weight based on 100% by weight of the fly ash. In some examples, the calcium oxide content of the fly ash may be from 23% by weight to 30% by weight based on 100% by weight of the fly ash.

In some embodiments, the majority of the fly ash present may be Class C fly ash (i.e., greater than 50% by weight of the fly ash present is Class C fly ash). In some examples, greater than 75% by weight, greater than 85% by weight, or greater than 95% by weight of the fly ash present may be Class C fly ash. For example, greater than 75% by weight, greater than 76% by weight, greater than 77% by weight, greater than 78% by weight, greater than 79% by weight, greater than 80% by weight, greater than 81% by weight, greater than 82% by weight, greater than 83% by weight, greater than 84% by weight, greater than 85% by weight, greater than 86% by weight, greater than 87% by weight, greater than 88% by weight, greater than 89% by weight, greater than 90% by weight, greater than 91% by weight, greater than 92% by weight, greater than 93% by weight, greater than 94% by weight, greater than 95% by weight, greater than 96% by weight, greater than 97% by weight, greater than 98% by weight, or greater than 99% by weight of the fly ash present may be Class C fly ash. In some embodiments, the fly ash consists of Class C fly ash. In some embodiments, blends of Class C fly ash and Class F fly ash can be used, particularly if the overall CaO content is as discussed above.

In other embodiments, the majority of the fly ash present can be Class F fly ash (i.e., greater than 50% by weight of the fly ash present is Class F fly ash). In some examples, greater than 75% by weight, greater than 85% by weight, or greater than 95% by weight of the fly ash present may be Class F fly ash. For example, greater than 75% by weight, greater than 76% by weight, greater than 77% by weight, greater than 78% by weight, greater than 79% by weight, greater than 80% by weight, greater than 81% by weight, greater than 82% by weight, greater than 83% by weight, greater than 84% by weight, greater than 85% by weight, greater than 86% by weight, greater than 87% by weight, greater than 88% by weight, greater than 89% by weight, greater than 90% by weight, greater than 91% by weight, greater than 92% by weight, greater than 93% by weight, greater than 94% by weight, greater than 95% by weight, greater than 96% by weight, greater than 97% by weight, greater than 98% by weight, or greater than 99% by weight of the fly ash present may be Class F fly ash. In some embodiments, the fly ash consists of Class F fly ash.

In an embodiment, the fly ash is present in an amount of from 35% by weight to 80% by weight based on 100% by weight of the polyurethane composite core. In another embodiment, the fly ash may be present in an amount of from 40% by weight to 60% by weight based on 100% by weight of the polyurethane composite core. In another embodiment, the fly ash may be present in an amount of greater than or equal to 50% by weight based on 100% by weight of the polyurethane composite core. For example, the fly ash may be present in an amount of from 40% by weight to 75% by weight based on 100% by weight of the polyurethane composite core. In some embodiments, the amount of fly ash present may be 35% by weight, 36% by weight, 37% by weight, 38% by weight, 39% by weight, 40% by weight, 41% by weight, 42% by weight, 43% by weight, 44% by weight, 45% by weight, 46% by weight, 47% by weight, 48% by weight, 49% by weight, 50% by weight, 51% by weight, 52% by weight, 53% by weight, 54% by weight, 55% by weight, 56% by weight, 57% by weight, 58% by weight, 59% by weight, 60% by weight, 61% by weight, 62% by weight, 63% by weight, 64% by weight, 65% by weight, 66% by weight, 67% by weight, 68% by weight, 69% by weight, 70% by weight, 71% by weight, 72% by weight, 73% by weight, 74% by weight, 75% by weight, 76% by weight, 77% by weight, 78% by weight, 79% by weight, or 80% by weight based on 100% by weight of the polyurethane composite core.

In other embodiments, the subject matter described herein is directed to a composite material comprising:
a cementitious layer comprising cement in an amount of greater than or equal to 60% by weight based on 100% by weight of the cementitious layer; and
a polyurethane composite core having a first planar surface, wherein the polyurethane composite core comprises fly ash in an amount of from 35% by weight to 80% by weight based on 100% of the polyurethane composite core;
wherein the cementitious layer is in physical communication with the first planar surface.

Useful polyurethane composite core materials include those described above. In a particular embodiment, the polyurethane composite core is a foamed polyurethane composite core formed by the reaction of at least one isocyanate at least one polyol as described above. The reaction of at least one isocyanate and at least one polyol is in the presence of fly ash, such as Class C fly ash at 50% by weight of the polyurethane composite core.

Useful cementitious layer components are those described elsewhere herein. In these embodiments, the cementitious coating (and at least a portion of the cementitious layer(s) that comprise the coating) defines a plurality of entrained pores, wherein the lightweight aggregate is disposed within the plurality of entrained pores. Two or more of the plurality of entrained pores may interconnect to form a network. In this aspect, the plurality of entrained pores defined by the cementitious layer(s) may be water-absorptive.

In embodiments, data provided elsewhere herein show that the cementitious layer defining the plurality of entrained pores, wherein lightweight aggregate is disposed within the plurality of pores, has a density when normalized for thickness that is 60% lower compared to a cementitious layer that does not include the lightweight aggregate, or 50% lower compared to a cementitious layer that does not include the lightweight aggregate, or 40% lower compared to a cementitious layer that does not include the lightweight aggregate, or 30% lower compared to a cementitious layer that does not include the lightweight aggregate, or 20% lower compared to a cementitious layer that does not include the lightweight aggregate, or 10% lower compared to a cementitious layer that does not include the lightweight aggregate, 8% lower compared to a cementitious layer that does not include the lightweight aggregate, or 6% lower compared to a cementitious layer that does not include the lightweight aggregate, or 4% lower compared to a cementitious layer that does not include the lightweight aggregate, or 2% lower compared to a cementitious layer that does not include the lightweight aggregate.

In embodiments, the polyurethane composite core is essentially free of fiber.

In embodiments, the composite material comprises:
a cementitious layer comprising cement in an amount of from 60% by weight to 80% by weight based on 100% by weight of the cementitious layer;
wherein the cement is a blend of Portland cement, Type I and Portland cement, Type III and is present in a ratio of Portland cement, Type I to Portland cement, Type III of from 1:5 to 5:1;
wherein the cementitious layer defines a plurality of entrained pores;
lightweight aggregate disposed in the plurality of entrained pores;
wherein the lightweight aggregate is selected from the group consisting of foamed glass beads, natural mineral perlite, and combinations thereof and is present in an amount of from 0.1% by weight to 10% by weight based on 100% by weight of the cementitious layer; and
a polyurethane composite core or a foamed polyurethane composite core having a first planar surface and a second planar surface disposed opposite the first planar surface, wherein the polyurethane composite core or the foamed polyurethane composite core comprises:
Class C fly ash present in an amount of from 40% by weight to 60% by weight based on 100% by weight of the polyurethane composite core or the foamed polyurethane composite core;
wherein the composite material has a density of from 0.16 g/cm³ to 0.32 g/cm³;
wherein the cementitious layer and the polyurethane composite core or the foamed polyurethane composite core are in continuous physical communication at the first planar surface and the second planar surface without any adhesive therebetween;
wherein the composite material has a three-dimensional, engineered shape prepared from a mold, and wherein the composite material does not include a veil, scrim, or mesh.

In embodiments, the composite material comprises:
a cementitious layer comprising:
   cement in an amount of from 60% by weight to 80% by weight based on 100% by weight of the cementitious layer; and
   foamed glass beads in an amount of from 5% by weight to 10% by weight based on 100% by weight of the cementitious layer;
   wherein the cement comprises Portland cement, Type I;
      wherein the cementitious layer defines a plurality of entrained pores;
      wherein the foamed glass beads are disposed within the plurality of entrained pores; and
   a polyurethane composite core or a foamed polyurethane composite core having a first planar surface and a second planar surface disposed opposite the first planar surface, wherein the polyurethane composite core or the foamed polyurethane composite core comprises:
      Class C fly ash present in an amount of from 40% by weight to 60% by weight based on 100% by weight of the polyurethane composite core or the foamed polyurethane composite core;
      wherein the polyurethane composite core or the foamed polyurethane composite core is a reaction product of at least one polyol and at least one isocyanate in the presence of the Class C fly ash, wherein the at least one isocyanate is selected from the group consisting of diisocyanates, polyisocyanates, and combinations thereof;
      wherein the cementitious layer and the polyurethane composite core or the foamed polyurethane composite core are in continuous physical communication at the first planar surface and the second planar surface without any adhesive therebetween;
      wherein the composite material is a three-dimensional, engineered panel prepared from a mold, wherein the composite material does not include a veil, scrim, or mesh, and wherein the polyurethane composite core or the foamed polyurethane composite core is essentially free of fibers.

In embodiments, the composite material comprises:
a cementitious layer comprising:
   cement in an amount of from 60% by weight to 80% by weight based on 100% by weight of the cementitious layer; and
   expanded perlite in an amount of from 0.1% by weight to 5% by weight based on 100% by weight of the cementitious layer;
   wherein the cement comprises Portland cement, Type I;
   wherein the cementitious layer defines a plurality of entrained pores;
   wherein the expanded perlite is disposed in the plurality of entrained pores; and
a polyurethane composite core or a foamed polyurethane composite core having a first planar surface and a second planar surface disposed opposite the first planar surface, wherein the polyurethane composite core or the foamed polyurethane composite core comprises:
   Class C fly ash present in an amount of from 40% by weight to 60% by weight based on 100% by weight of the polyurethane composite core or the foamed polyurethane composite core;
   wherein the polyurethane composite core or the foamed polyurethane composite core is a reaction product of at least one polyol and at least one isocyanate selected from the group consisting of diisocyanates, polyisocyanates, and combinations thereof in the presence of the Class C fly ash;
   wherein the cementitious layer and the polyurethane composite core or the foamed polyurethane composite core are in continuous physical communication at the first planar surface and the second planar surface without any adhesive therebetween;
wherein the composite material is a three-dimensional, engineered panel prepared from a mold, wherein the composite material does not comprise a veil, scrim, or mesh, and wherein the polyurethane composite core or the foamed polyurethane composite core is essentially free of fibers.

The composite materials described herein can:
a. Withstand greater than 50 freeze-thaw cycles without failure.

The composite material may not crack after greater than or equal to 50 free-thaw cycles in which water penetrates the plurality of entrained pores, is first frozen to and maintained at a temperature of −10° C. for 3 hours, and is subsequently thawed to and maintained at a temperature of 10° C. for 1 hour. In certain aspects, the composite material can withstand greater than 100 freeze-thaw cycles without failure. In certain aspects, the composite material can withstand greater than 150 freeze-thaw cycles without failure. In certain aspects, the composite material can withstand up to or greater than 200 freeze-thaw cycles without failure. In certain aspects, the composite material can withstand up to or greater than 225 freeze-thaw cycles without failure and may never fail under test conditions.
b. Resist cracking and separation at elevated temperatures.

The composite material may not crack for at least 24 hours at a temperature of from 50° C. to 100° C. In certain aspects, the composite material can withstand elevated temperatures and resist cracking induced by the temperature. In certain aspects, the composite material can withstand temperatures from 50° C. to 100° C. for at least 24 hours and up to one week or more. In certain aspects, the composite material can withstand temperatures from 60° C. to 100° C. for at least 24 hours and up to one week or more. In certain aspects, the composite material can withstand temperatures from 70° C. to 100° C. for at least 24 hours and up to one week or more. In certain aspects, the composite material can withstand temperatures from 80° C. to 100° C. for at least 24 hours and up to one week or more. In certain aspects, the composite material can withstand temperatures of 80° C. for at least 24 hours and up to one week or more. The cementitious layer may be directly attached to the polyurethane composite core without the use of an adhesive and is able to maintain adherence or attachment at high temperatures.
c. Exhibit Low Density, Robust Flexural Strength and Modulus.

In certain aspects, the composite material has an overall density of from 0.27 g/cm³ or 17.0 pcf to 0.34 g/cm³ or 21.0 pcf, or from 0.28 g/cm³ or 17.5 pcf to 0.30 g/cm³ or 19.0 pcf, or from 0.29 g/cm³ or 17.8 pcf to 0.30 g/cm³ or 18.5 pcf. Additionally, in certain aspects, the composite material may have a flexural strength of from 2.07 MPa to 5.17 MPa. For example, the composite material may have a flexural strength of from 2.07 MPa or 300 psi to 3.10 MPa or 450 psi, or from 2.07 MPa or 300 psi to 2.76 MPa or 400 psi, or from 2.07 MPa or 300 psi to 2.59 MPa or 375 psi, or from 2.14 MPa or 310 psi to 2.41 MPa or 350 psi. Additionally, in certain aspects, the composite material may have a modulus of from 413.69 MPa or 60 ksi to 896.32 MPa or 130 ksi, or from 482.63 MPa or 70 ksi to 861.84 MPa or 125 ksi, or from 517.11 MPa or 75 ksi to 689.48 MPa or 100 ksi. In certain aspects, the relationship between density and flexural strength is improved, such that density increases provide superior enhancement of flexural strength relative to a composite material lacking a cementitious layer defining the plurality of entrained pores and having lightweight aggregate disposed within the plurality of entrained pores. In certain aspects, the relationship between density and modulus is improved, such that density increases provide superior enhancement of modulus relative to composite materials lacking a cementitious layer defining the plurality of entrained pores and having lightweight aggregate disposed within the plurality of entrained pores.

In embodiments, the polyurethane composite core further comprises the second planar surface and the second cementitious layer, and the second cementitious layer is in physical communication with the second planar surface. The cementitious layer and the second cementitious layer may be in physical communication and may wrap around the polyurethane composite core to form a continuous cementitious layer that encapsulates the polyurethane composite core.

In embodiments, the polyurethane composite core may be formed by the reaction of an isocyanate (such as diisocyanates and polyisocyanates), a polyol, and fly ash and may have a cementitious layer disposed on opposite planar surfaces (i.e., the first planar surface and the second planar surface) of the polyurethane composite core, wherein the cementitious layer is composed of:
cement (Portland cement (Type I)) in an amount of greater than or equal to 60% by weight based on 100% of the cementitious layer, and calcium sulfoaluminate cement in a ratio of Portland cement, Type I to calcium sulfoaluminate cement of 4:1, or a ratio of 3:2, or a ratio of 1:1, or a ratio of 2:3, or a ratio of 1:4.
methyl cellulose or hydroxymethyl cellulose in an amount of from 0.1% by weight to 5% by weight based on 100% by weight of the cementitious layer;
chopped fiberglass in an amount of from 1% by weight to 10% by weight based on 100% by weight of the cementitious layer;
a superplasticizer in an amount of from 0.1% by weight to 5% by weight based on 100% of the cementitious layer; and
a lightweight aggregate in an amount of from 0.01% by weight to 30% by weight based on 100% by weight of the cementitious layer, wherein in particular, the lightweight aggregate is foamed glass beads or expanded perlite. Specifically, when expanded perlite is present, the expanded perlite may be present in an amount of from 0.01% by weight to 5% by weight based on 100% by weight of the cementitious layer. Specifically, when foamed glass beads are present, the foam glass beads may be present in an amount of from 2% by weight to 30% by weight based on 100% by weight of the cementitious layer.

In embodiments, the polyurethane composite core may be a polyurethane based on a polyether- or polyester-based polyol and a diisocyanate or polyisocyanate that comprises MDI, PMDI, TDI, or alkyl isocyanates, and the polyol can contain an aromatic content and can incorporate a Mannich derived polyol(s); the cementitious layer may be disposed on opposite planar surfaces of the polyurethane composite core, wherein the cementitious layer is composed of:
Portland cement in an amount of greater than or equal to 60% by weight based on 100% by weight of the cementitious layer, e.g., greater than or equal to 70% by weight or greater than or equal to 80% by weight;
methyl cellulose or hydroxymethyl cellulose present in an amount of from 0.1% by weight to 5% by weight based on 100% by weight of the cementitious layer;
chopped fiberglass present in an amount of from 1% by weight to 10% by weight based on 100% by weight of the cementitious layer;
a superplasticizer present in an amount of from 0.1% by weight to 5% by weight based on 100% by weight of the cementitious layer; and
a lightweight aggregate present in an amount of from 0.01% by weight to 30% by weight based on 100% by weight of the cementitious layer, wherein in particular, the lightweight aggregate is expanded perlite or foamed glass beads. Specifically, when expanded perlite is present, the expand perlite may be present in an amount of from 0.01% by weight to 5% by weight based on 100% by weight of the cementitious layer. Specifically, when foamed glass beads are present, the foamed glass beads may be present in an amount of from 2% by weight to 30% by weight based on 100% by weight of the cementitious layer.

In embodiments, the polyurethane composite core is a polyurethane based on a polyether- or polyester-based polyol and a diisocyanate or polyisocyanate that comprises MDI, PMDI, TDI, or alkyl isocyanates and the polyol can contain an aromatic content and can incorporate a Mannich derived polyol(s); the cementitious layer is disposed on opposite planar surfaces of the polyurethane composite core, wherein the cementitious layer is composed of:
calcium sulfoaluminate cement as the only cement in an amount of greater than or equal to 60% by weight, e.g., greater than 70% by weight or greater than 80% by weight based on 100% by weight of the cementitious layer;
methyl cellulose or hydroxymethyl cellulose in an amount of from 0.1% by weight to 5% by weight based on 100% by weight of the cementitious layer;
chopped fiberglass in an amounts of from 1% by weight to 10% by weight based on 100% by weight of the cementitious layer;
a superplasticizer in an amount of from 0.1% by weight to 5% by weight based on 100% by weight of the cementitious layer; and
a lightweight aggregate in an amount of from 0.01% by weight to 40% by weight based on 100% by weight of the cementitious layer, wherein in particular, the lightweight aggregate is expanded perlite or foamed glass beads. Specifically, when expanded perlite is present, the expanded perlite may be present in an amount of from 0.01% by weight to 5% by weight based on 100% by weight of the cementitious layer. Specifically, when foamed glass beads are present, the foamed glass beads may be present in an amount of from 2% by weight to 30% by weight based on 100% by weight of the cementitious layer.

In embodiments, the lightweight aggregate is foamed glass beads, and the composite material has a density of from 0.29 g/cm³ or 18 pcf to 0.30 g/cm³ or 19 pcf; a flexural strength of from 2.14 MPa or 310 psi to 2.83 MPa or 410 psi; and/or a modulus of from 551.58 MPa or 80 ksi to 792.90 MPa or 115 ksi. In embodiments, the lightweight aggregate is expanded perlite, and the composite material has a density of from 0.30 g/cm³ or 19 pcf to 0.32 g/cm³ or 20 pcf; a flexural strength of from 2.14 MPa or 310 psi to 2.48 MPa or 360 psi; and/or a modulus of from 551.58 MPa or 80 ksi to 620.53 MPa or 90 ksi.

Additional components useful with the compositions or composite materials described herein are disclosed in US 2011/0086934 and WO 2016/195717, each of which is incorporated by reference in its entirety. Additional components may include fillers, water reducers, plasticizers, pigments, foaming agents (e.g., air-entraining agents) or blowing agents, anti-efflorescence agents, photocatalysts, ultraviolet light stabilizers, fire retardants, antimicrobials, and antioxidants.

One or more fillers can include types of ash such as those produced by firing fuels including industrial gases, petroleum coke, petroleum products, municipal solid waste, paper sludge, wood, sawdust, refuse derived fuels, switchgrass, or other biomass material; ground/recycled glass (e.g., window or bottle glass); milled glass; glass spheres; glass flakes; activated carbon; calcium carbonate; aluminum trihydrate (ATH); silica; sand; alluvial sand; natural river sand; ground sand; crushed granite; crushed limestone; silica fume; slate dust; crusher fines; red mud; amorphous carbon (e.g., carbon black); clays (e.g., kaolin); mica; talc; wollastonite; alumina; feldspar; bentonite; quartz; garnet; saponite; beidellite; granite; calcium oxide; calcium hydroxide; antimony trioxide; barium sulfate; magnesium oxide; titanium dioxide; zinc carbonate; zinc oxide; nepheline syenite; perlite; diatomite; pyrophillite; flue gas desulfurization (FGD) material; soda ash; trona; soy meal; pulverized foam; and mixtures thereof. For instance, limestone filler can be present in the cementitious layer (e.g., present in the entrained pores) in an amount of from greater than 0% by weight to 80% by weight, or from 5% by weight to 70% by weight, or from 10% by weight to 60% by weight based on 100% by weight of the cementitious layer. The one or more fillers (e.g., inert filler such as limestone) can have a median size of greater than or equal to 50 microns, for example, from 50 microns to 500 microns, or from 100 microns to 400 microns, or from 150 microns to 300 microns. The one or more fillers may be monomodal, bimodal, or trimodal.

Water reducers can be included in the compositions or composite materials described herein to reduce the amount of water in the polyurethane and cementitious layer while maintaining the workability, fluidity, and/or plasticity of the polyurethane and cementitious layer. Examples of suitable water reducers may include lignin, naphthalene, melamine, polycarboxylates, lignosulfates and formaldehyde condensates (e.g., sodium naphthalene sulfonate formaldehyde condensate). In some examples, the water reducer is a high-range water reducer, such as, for example, a superplasticizer. Standard plasticizers can also be included in the compositions described herein. Examples of suitable plasticizers for use with the composite materials described herein may include clays (e.g., bentonite, expanded clay, and kaolin clay), and JEFFSPERSE® X3202, JEFFSPERSE® X3202RF, and JEFFSPERSE® X3204, each commercially available from Huntsman Polyurethanes; Geismar, La. Water reducers can be provided in an amount of 0.01% by weight to 6% by weight based on 100% by weight of the cementitious layer. For example, the water reducers can be included in an amount of from 0.05% by weight to 5% by weight, from 0.1% by weight to 4% by weight, or from 0.5% by weight to 3% by weight based on 100% by weight of the cementitious layer.

Pigments or dyes can optionally be added to the compositions or composite materials described herein. An example of a pigment is iron oxide, which can be added in amounts ranging from 1% by weight to 7% by weight or 2% by weight to 6% by weight, based on 100% by weight of the cementitious layer.

Anti-efflorescence agents can be included in the compositions or composite materials. Suitable anti-efflorescence agents may include siloxanes, silanes, stearates, amines, fatty acids (e.g., oleic acid and linoleic acid), organic sealants (e.g., polyurethanes or acrylics), and inorganic sealants (e.g., polysilicates). Anti-efflorescence agents can be included in the compositions or composite materials in an amount of from 0.01% by weight to 1% by weight based on 100% by weight of the cementitious layer or added topically to the product surfaces.

Photocatalysts such as anatase (titanium dioxide) can be used that produce superoxidants that can oxidize NOx and volatile organic components (VOCs) to reduce pollution. The photocatalysts can make the composite material super hydrophobic and self-cleaning (e.g., in the presence of smog). These materials can also act as antimicrobials and have impact on algae, mold, and/or mildew growth. Such materials are disclosed in U.S. Pat. No. 8,795,428, herein incorporated by reference in its entirety.

Surfactants can be used as wetting agents and to assist in mixing and dispersing the materials in the composite material. Surfactants can also stabilize and control the size of bubbles formed during the foaming event and the resultant cell structure. Surfactants can be used, for example, in amounts below 0.5% by weight based on 100% by weight of a mixture. Examples of surfactants useful with the polyurethanes described herein may include anionic, non-ionic and cationic surfactants. For example, silicone surfactants such as Tegostab® B-8870, DC-197 and DC-193 (Air Products; Allentown, Pa.) can be used. In embodiments, the composite material does not contain a surfactant. As described elsewhere herein, in the cementitious layer, surfactants at levels that provide surfactant functionality may be avoided to minimize or prevent air entrapment.

Low molecular weight reactants such as chain-extenders and/or crosslinkers can be included in the composite materials described herein. These reactants may help the polyurethane system to distribute and contain the fillers, fibers, etc., within the polyurethane composite core. Chain-extenders are functional molecules, such as diols or diamines, which can polymerize to lengthen the urethane polymer chains. Examples of chain-extenders may include ethylene glycol; 1,4-butanediol; ethylene diamine, 4,4′-methylenebis(2-chloroaniline) (MBOCA); diethyltoluene diamine (DETDA); and aromatic diamines such as Unilink 4200 (commercially available from UOP). Crosslinkers are tri- or greater functional molecules that can integrate into a polymer chain through two functionalities and provide one or more further functionalities (i.e., linkage sites) to crosslink to additional polymer chains. Examples of crosslinkers may include glycerin, trimethylolpropane, sorbitol, diethanolamine, and triethanolamine. In some composites, a crosslinker or chain-extender may be used to replace at least a portion of the one or more polyols in the composite material. For example, the polyurethane can be formed by the reaction of an isocyanate, a polyol, and a crosslinker.

Coupling agents and other surface treatments such as viscosity reducers, flow control agents, or dispersing agents can be added directly to the filler or fiber, or incorporated prior to, during, and/or after the mixing and reaction of the composite material. Coupling agents can allow higher filler loadings of the particulate filler such as fly ash and/or the lightweight filler and may be used in small quantities. For example, the composite material may comprise a coupling agent present in an amount of from 0.01% by weight to 0.5% by weight based on 100% by weight of the composite material. Examples of coupling agents useful with the composite materials described herein may include Ken-React® LICA® 38 and Ken-React® KR® 55 (Kenrich Petrochemicals; Bayonne, N.J.). Examples of dispersing agents useful with the composite materials described herein may include JEFFSPERSE® X3202, JEFFSPERSE® X3202RF, and JEFFSPERSE® X3204 (Huntsman Polyurethanes; Geismar, La.).

Ultraviolet (UV) light stabilizers, such as UV absorbers, can be added to the compositions or composite materials described herein. Examples of UV light stabilizers may include hindered amine type stabilizers and opaque pigments like carbon black powder. Fire retardants can be included to increase the flame or fire resistance of the compositions or composite materials. Antimicrobials, such as copper complexes, can be used to limit the growth of mildew and other organisms on the surface of the compositions or composite materials. Antioxidants, such as phenolic antioxidants, can also be added. Antioxidants can provide increased UV protection, as well as thermal oxidation protection.

The proportions of cementitious layer, lightweight aggregate, additives and fillers can be varied to obtain optimal properties for a particular application (e.g., siding, roofing, trim, soffit, backer board for tile underlay, etc.). It will be appreciated that the percentage of cementitious layer and lightweight aggregate may be varied depending on the desired application. In an embodiment, one composition may include Portland cement in an amount of from 70% by weight to 99% by weight, lightweight aggregate present in an amount of from 0.1% by weight to 20% by weight, and additives present in an amount of from 0.01% by weight to 15% by weight based on 100% by weight of the cementitious layer. In a further embodiment, the additives may include chopped fiberglass in an amount of from 0.01% by weight to 10% by weight, superplasticizer in an amount of from 0.01% by weight to 1% by weight, and fiber in an amount of from 0.01% by weight to 2% by weight, such as methyl cellulose, based on 100% by weight of the cementitious layer.

### III. Methods of Manufacture

Described herein are methods of producing a building material formed from the composite material. The method includes: contacting the polyurethane composite core with the cementitious layer; and curing the cementitious layer to dispose the cementitious layer in physical communication with the polyurethane composite core without disposing an adhesive between the cementitious layer and the polyurethane composite core.

The polyurethane composite core can be prepared by preparing a polymer composition and curing to form the polyurethane composite core. The core can be prepared using the following techniques: extrusion, casting, injection molding, calendaring, blow molding, compression molding, thermoforming, and vacuum forming. In the case of polyurethanes, the polyurethane can be formed in accordance with certain techniques. For example, polyurethanes can be prepared using the methods disclosed in U.S. Pat. Nos. 9,512,288; 7,879,144; U.S. 2011/0086934; and U.S. 2014/0349104, each of which is incorporated by reference in its entirety.

The polyurethane composite core can be formed by the reaction of one or more isocyanates, selected from the group consisting of diisocyanates, polyisocyanates, and combinations thereof, and one or more polyols, in the presence of one or more fillers, one or more additives, and/or a catalyst. In some embodiments, the polyurethane composite core can be produced by mixing the one or more isocyanates, the one or more polyols, the one or more fillers, etc., in a mixing apparatus such as a high speed mixer or an extruder. In some embodiments, mixing can be conducted in an extruder. The materials can be added in any suitable order. For example, in some embodiments, the mixing stage of the method used to prepare the polyurethane composite core can include: mixing the polyol and any filler; mixing the isocyanate with the polyol and any filler; and optionally mixing the catalyst with the isocyanate, the polyol, and any filler. Fillers can be added at the same time, or can be added at different times or the same stage, e.g., prior to, during, or after any mixing stage.

The polyurethane composite core can be blended in any suitable manner to obtain a homogeneous or heterogeneous blend of the one or more isocyanate, one or more polyol, any fillers, and optional catalyst. An ultrasonic device can be used for enhanced mixing and/or wetting of the various components that compose the polyurethane composite core. The ultrasonic device may produce an ultrasound of a certain frequency that can be varied during the mixing and/or extrusion process. The ultrasonic device useful in the preparation of composite materials described herein can be attached to or adjacent to an extruder and/or mixer. For example, the ultrasonic device can be attached to a die or nozzle or to the port of an extruder or mixer. An ultrasonic device may provide de-aeration of undesired gas bubbles and better mixing for the other components, such as blowing agents, surfactants, and catalysts.

The mixture that will form the polyurethane composite core can then be extruded into a mold cavity of a mold, the mold cavity defined by at least an interior mold surface. The mold can be a continuous forming system such as a belt molding system or can include individual batch molds. The belt molding system can include a mold cavity defined at least in part by opposing surfaces of two opposed belts. A molded article can then be formed followed by removal of the article from the mold.

The polyurethane mixture may be processed at an elevated temperature (e.g., from 93.33° C. or 200° F. to from 260° C. or 500° F.) to form a melt and to allow the mixture to have a workable viscosity. In some embodiments, any filler(s) are heated before mixing with the polyurethane. The molten filled polyurethane (that is, the polyurethane and any fillers) can have a workable viscosity of 25 Pa*s to 250 Pa*s. The viscosity of the mixture can be measured using a Thermo Electron Corporation Haake Viscometer.

In some embodiments, the polyurethane composite core can be foamed. The polyol and the isocyanate can be allowed to produce a foamed polyurethane composite core after mixing the components according to the methods described herein. The polyurethane composite core can be formed while they are actively foaming or after they have foamed. For example, the material can be placed under the pressure of a mold cavity prior to or during the foaming of the material that will compose the polyurethane composite core.

In some embodiments, the polyurethane composite core can be free or substantially free of a blowing or foaming agent other than water. The foamed polyurethane composite core can include closed or open cells depending on the blowing or foaming agents used.

With respect to the cementitious compositions that will form the cementitious layers and coating, the cementitious compositions and cementitious layer can be prepared using the following techniques. In general, when preparing the cementitious compositions, components can be mixed from 2 seconds to 5 minutes or more in the presence of water. The water can be provided in the mixture by adding water directly to the cement. The water to cement ratio, based on an amount of water to an amount of cement, can be from 0.06:1 to 0.5:1, depending on the product being made and the process being used for producing the product. In some embodiments, the water to cement ratio can be from 0.06:1 to 0.25:1, from 0.09:1 to less than 0.15:1, or from 0.095:1 to less than 0.14:1 (e.g., less than 0.10:1). For example, the water to cement ratio can be from 0.06:1 to less than 0.15:1. In some embodiments, the water to cement ratio can be from 0.15:1 to 0.4:1, particularly when other additives are used that absorb a significant amount of water (e.g., 20%-30%). In some embodiments, the water to cement ratio is from 0.15:1 to 0.25:1 or can be from 0.25 to 0.4:1. The water to cement ratio can be 0.06:1, 0.07:1, 0.08:1, 0.09:1, 0.10:1, 0.11:1, 0.12:1, 0.13:1, 0.14:1, 0.15:1, 0.16:1, 0.17:1, 0.18:1, 0.19:1, 0.20:1, 0.21:1, 0.22:1, 0.23:1, 0.24:1, 0.25:1, 0.26:1, 0.27:1, 0.28:1, 0.29:1, 0.30:1, 0.31:1, 0.32:1, 0.33:1, 0.34:1, 0.35:1, 0.36:1, 0.37:1, 0.38:1, 0.39:1, or 0.40:1.

In some examples, the components are mixed for a period of 15 seconds or less (e.g., for from 2 seconds to 10 seconds or from 4 seconds to 10 seconds). The mixing times can result in a homogenous mixture. The mixing can be performed at an elevated temperature (e.g., up to 71.11° C. or 160° F.) or at ambient temperature. In some embodiments, the mixing occurs at ambient temperature. The components are allowed to react to form the cementitious composition, which is subsequently cured to form the cementitious layer disposed on the polyurethane composite core. Techniques include those described in US 2012/0085264, herein incorporated by reference in its entirety.

The cementitious composition, which is cured to form the cementitious layer, can be produced using a batch, semi-batch, or continuous process. At least a portion of the mixing step, reacting step, or both, can be conducted in a mixing apparatus such as a high speed mixer, a high shear mixer, or an extruder. The method can further include extruding the resulting cementitious composition through a die or nozzle. In some embodiments, mixing used to prepare the cementitious compositions described herein includes combining components in and adding any additional water to provide a desired consistency.

An ultrasonic or vibrating device can be used for enhanced mixing and/or wetting of the various components of the cementitious compositions described herein. The ultrasonic or vibrating device produces an ultrasound of a certain frequency that can be varied during the mixing and/or extrusion process. Alternatively, a mechanical vibrating device can be used. The ultrasonic or vibrating device useful in the preparation of cementitious compositions described herein can be attached to or adjacent to an extruder and/or mixer. For example, the ultrasonic or vibrating device can be attached to a die or nozzle or to the exit port of an extruder or mixer. An ultrasonic or vibrating device may provide de-aeration of undesired gas bubbles and better mixing for the other components, such as blowing agents, plasticizers, and pigments.

Once the polyurethane composite core and the cementitious composition are provided, the method may include contacting the cementitious composition with the polyurethane composite core. For example, the polyurethane composite core can be passed under nozzles from which the cementitious composition is extruded onto the polyurethane composite core. The polyurethane composite core can be moved under the nozzles at a rate whereby the desired amount of cementitious composition is contacted with the polyurethane composite core to prepare a composite material having a single-layer cementitious layer of the desired thickness on one planar surface, e.g., the first planar surface. The process can be repeated on the same planar surface or other surfaces, e.g., the second planar surface, as desired.

Suitable surfaces for application of the cementitious composition or mixture may include, for example, conveying belts. In some embodiments, the cementitious composition can be applied directly onto the polyurethane composite core; however, an adhesive layer can alternatively be applied between the polyurethane composite core and the cementitious mixture. The cementitious composition or mixture can be allowed to harden, cure and/or set to thereby form the cementitious layer.

Curing can be at elevated temperature or at ambient temperature. Curing can occur for several hours, days, years, or more. Sufficient curing to prepare the cementitious layers can occur under controlled conditions in 24 hours or less, 18 hours or less, 12 hours or less, 10 hours or less, 9 hours or less, 8 hours or less, 7 hours or less, 6 hours or less, 5 hours or less, 4 hours or less, 3 hours or less, 2 hours or less, 1 hour or less, or 30 minutes or less at ambient temperature. Curing can occur at an elevated temperature in a range of from 121.11° C. or 250° F. to 260° C. or 500° F., optionally in the presence of water vapor (instead of or in addition to the ambient temperature cure).

In embodiments, the cementitious layer of the composite materials define the plurality of entrained pores in which lightweight aggregate is disposed. In these embodiments, the lightweight aggregate may be admixed with a cement mixture, prior to contacting with the polyurethane composite core. That is, the method may further comprise preparing the cementitious layer by admixing lightweight aggregate with a mixture comprising the cement and water. The lightweight aggregate may be selected from the group consisting of natural mineral perlite and foamed glass beads, and the lightweight aggregate may be present in an amount of from 2% by weight to 30% by weight based on 100% by weight of the cementitious layer.

The method may further comprise, prior to contacting, providing the polyurethane composite core and shaping at least the first planar surface, e.g., the first planar surface and the second planar surface. Contacting may include disposing the cementitious layer on the first planar surface and the second planar surface. Curing may include forming a continuous cementitious layer in physical communication with the first planar surface and the second planar surface.

The resulting composite materials retain desirable flexural strength and modulus properties. In embodiments, it has been found that the selection of lightweight aggregate and the mixing conditions can provide superior properties to the composite material. In these embodiments, the process of manufacturing may include mixing the lightweight aggregate in a cement, including cement blends, wherein the lightweight aggregate is as described elsewhere herein. In embodiments, the lightweight aggregate is a foamed glass bead, which can withstand higher mixing energy. In embodiments, the lightweight aggregate is added at a later stage of mixing to minimize the lightweight aggregates' exposure to mixing.

Admixing may include high-shear mixing the cement and water to form the mixture, and after high-shear mixing, low-shear mixing the lightweight aggregate and the mixture to form the cementitious layer. In embodiments, the mixing may be at low shear. In embodiments, the mixing may begin at high shear and may be adjusted to low shear prior to the addition of the lightweight aggregate. In a particular embodiment, the cement, water, the viscosity modifying admixture, and fiberglass may be mixed at high shear for 5 minutes. The mix speed may then be reduced and immediately the superplasticizer and lightweight aggregate may be added. The mix may continue at low shear for 1 minute. The slurry or cementitious composition can then be immediately contacted with the polyurethane composite core.

The subject matter described herein includes, but is not limited to, the following specific embodiments:

1. A composite material comprising:

a cementitious layer comprising cement in an amount of greater than or equal to 60% by weight based on 100% by weight of the cementitious layer; and

a polyurethane composite core having a first planar surface, wherein the polyurethane composite core comprises fly ash in an amount of from 35% by weight to 80% by weight based on 100% by weight of the polyurethane composite core;

wherein the cementitious layer is in physical communication with the first planar surface.

2. The composite material of the above embodiment, wherein the cement is present in an amount of greater than or equal to 70% by weight based on 100% by weight of the cementitious layer.
3. The composite material of any of the above embodiments, wherein the cement is present in an amount of greater than or equal to 80% by weight based on 100% by weight of the cementitious layer.
4. The composite material of any of above embodiments 1-3, wherein the cement is selected from the group consisting of Portland cement, rapid-hardening cement, calcium aluminate cement, calcium sulfoaluminate cement, slag, other specialty type cements, a blend of cements, a blend of pozzolans, and combinations thereof.
5. The composite material of any of above embodiments 1-4, wherein the cement is selected from the group consisting of Portland cement, calcium sulfoaluminate cement, and combinations thereof.
6. The composite material of any of above embodiments 1-5, wherein the Portland cement is selected from the group consisting of Type I ordinary Portland cement (OPC), Type II OPC, Type III OPC, Type IV OPC, Type V OPC, low alkali Type I OPC, low alkali Type II OPC, low alkali Type III OPC, low alkali Type IV OPC, low alkali Type V OPC, and combinations thereof.
7. The composite material of any of above embodiments 1-6, wherein the cement is a blend of Type I OPC and calcium sulfoaluminate cement and is present in the cementitious layer in a ratio of Type I OPC to calcium sulfoaluminate cement of from 1:6 to 6:1.
8. The composite material of any of above embodiments 1-7, further comprising a plurality of cementitious layers, wherein a first cementitious layer is in physical communication with the first planar surface and a second cementitious layer is in physical communication with the first cementitious layer.
9. The composite material of any of above embodiments 1-8, wherein the cementitious layer has a thickness of less than or equal to 25 mm, or a thickness of 0.5 mm to 9 mm.
10. The composite material of any of the above embodiments, wherein the polyurethane composite core is foamed.
11. The composite material of any of embodiments 1-10, 12-69, 77 and 78, wherein the polyurethane composite core is a reaction product of at least one polyol and at least one isocyanate in the presence of the fly ash, wherein the at least one isocyanate is selected from the group consisting of diisocyanates, polyisocyanates, and combinations thereof, e.g., the polyurethane is based on a polyether- or polyester-based polyol and a diisocyanate or polyisocyanate that includes MDI, PMDI, TDI, or alkyl isocyanates and the polyol can contain an aromatic content and can incorporate a Mannich derived polyol(s).
12. The composite material of any of above embodiments 1-11, wherein the fly ash is present in an amount of from 40% by weight to 60% by weight based on 100% by weight of the polyurethane composite core.
13. The composite material of any of above embodiments 1-12, wherein the fly ash is present in an amount of greater than or equal to 50% by weight based on 100% by weight of the polyurethane composite core.
14. The composite material of any of above embodiments 1-13, wherein the fly ash is Class C fly ash or Class F fly ash.
15. The composite material of any of above embodiments 1-14, wherein the fly ash is Class C fly ash.
16. The composite material of any of above embodiments 1-15, wherein the polyurethane composite core further comprises at least one of a filler and an additive.
17. The composite material of any of above embodiments 1-16, wherein the polyurethane composite core has a thickness of from 5 mm to 250 mm.
18. The composite material of any of above embodiments 1-17, wherein the cementitious layer is directly attached to the polyurethane composite core without the use of an adhesive.
19. The composite material of any of above embodiments 1-18, wherein the cementitious layer is present in an amount of from 10% by weight to 60% by weight based on 100% by weight of the composite material, and wherein the polyurethane composite core is present in an amount of from 40% by weight to 90% by weight based on 100% by weight of the composite material.
20. The composite material of any of above embodiments 1-19, further comprising a lightweight aggregate;

wherein the cementitious layer defines a plurality of entrained pores therein that are water absorptive; and

wherein the lightweight aggregate is disposed in the plurality of entrained pores.

21. The composite material of any of above embodiments 1-20, wherein two or more of the plurality of entrained pores interconnect to form a network.
22. The composite material of any of above embodiments 1-21, wherein the lightweight aggregate is selected from the group consisting of natural mineral perlite, expanded perlite, hollow glass beads, foamed glass beads, ground silica sand, amorphous silica, diatomaceous earth, rice hull ash, blast furnace slag, granulated slag, steel slag, mineral oxides, mineral hydroxides, clays, magnasite, dolomite, layeric beads, volcanic tuff, pumice, ground tire rubber, metal oxides and hydroxides, and combinations thereof.
23. The composite material of any of above embodiments 1-22, wherein the lightweight aggregate is selected from the group consisting of expanded natural mineral perlite and foamed glass beads.
24. The composite material of any of above embodiments 1-23, wherein the lightweight aggregate is present in an amount of from 0.1% by weight to 30% by weight based on 100% by weight of the cementitious layer.
25. The composite material of any above embodiments 1-24, wherein the lightweight aggregate is present in an amount of from 0.1% by weight to 10% by weight based on 100% by weight of the cementitious layer.
26. The composite material of any of above embodiments 1-25, wherein the one or more filler is glass fibers.
27. The composite material of any of above embodiments 1-26, wherein the glass fibers are chopped fiberglass.
28. The composite material of any of above embodiments 1-27, wherein the composite material does not crack after greater than or equal to 50 freeze-thaw cycles in which water penetrates the plurality of entrained pores, is first frozen to and maintained at a temperature of −10° C. for 3 hours, and is subsequently thawed to and maintained at a temperature of 10° C. for 1 hour.
29. The composite material of any of above embodiments 1-28, wherein the polyurethane composite core does not crack for at least 24 hours at a temperature of from 50° C. to 100° C.
30. The composite material of any of above embodiments 1-29, wherein the composite material has a density from 0.16 g/cm³ or 10.0 pcf to 0.56 g/cm³ or 35.0 pcf.
31. The composite material of any above embodiments 1-30, wherein the composite material has a flexural strength from 2.07 MPa or 300 psi to 5.17 MPa or 750 psi, or from 2.07 MPa or 300 psi to 3.10 MPa or 450 psi.
32. The composite material of any of above embodiments 1-31, wherein the composite material has a modulus of from 137.90 MPa or 20 ksi to 2,068.43 MPa or 300 ksi, or from 413.69 MPa or 60 ksi to 896.32 MPa or 130 ksi.
33. The composite material of any of above embodiments 1-32, wherein the polyurethane composite core further comprises a second planar surface and a second cementitious layer, and wherein the second cementitious layer is in physical communication with the second planar surface.
34. The composite material of any of above embodiments 1-33, wherein the cementitious layer and the second cementitious layer are in physical communication and wrap around the polyurethane composite core to form a continuous cementitious layer that encapsulates the polyurethane composite core.
35. The composite material of any of above embodiments 1-34, wherein the polyurethane composite core has a three-dimensional, engineered shape prepared from a mold.
36. The composite material of any of above embodiments 1-35, wherein the three-dimensional, engineered shape is selected from the group consisting of synthetic stone, roofing tiles, ceramic tiles, architectural stone, thin bricks, backer boards, bricks, pavers, sheets, panels, boards, underlays, banisters, lintels, pipes, posts, signs, guard rails, retaining walls, park benches, tables, railroad ties, and combinations thereof.
37. The composite material of any of above embodiments 1-36, wherein the three-dimensional, engineered shape is a panel comprising the first planar surface and a second planar surface disposed opposite the first planar surface.
38. The composite material of any of above embodiments 1-37, wherein the panel is rectangular.
39. The composite material of any of above embodiments 1-38, wherein the panel has a width of 91.44 cm, a length of 152.40 cm, a thickness of less than or equal to 2.54 cm, and a weight of less than or equal to 13.61 kg.
40. The composite material of any of above embodiments 1-39, wherein the composite material does not contain a veil, scrim, or mesh.
41. A composite material comprising:

a cementitious layer comprising cement in an amount of from 60% by weight to 80% by weight based on 100% by weight of the cementitious layer;
wherein the cement is a blend of Portland cement, Type I and Portland cement, Type III and is present in a ratio of Portland cement, Type I to Portland cement, Type III of from 1:5 to 5:1;
wherein the cementitious layer defines a plurality of entrained pores;

lightweight aggregate disposed in the plurality of entrained pores;
wherein the lightweight aggregate is selected from the group consisting of foamed glass beads, natural mineral perlite, and combinations thereof and is present in an amount of from 0.1% by weight to 10% by weight based on 100% by weight of the cementitious layer; and

a polyurethane composite core or a foamed polyurethane composite core having a first planar surface and a second planar surface disposed opposite the first planar surface, wherein the polyurethane composite core or the foamed polyurethane composite core comprises:
Class C fly ash present in an amount of from 40% by weight to 60% by weight based on 100% by weight of the polyurethane composite core or the foamed polyurethane composite core;

wherein the composite material has a density of from 0.16 g/cm³ to 0.32 g/cm³;

wherein the cementitious layer and the polyurethane composite core or the foamed polyurethane composite core are in continuous physical communication at the first planar surface and the second planar surface without any adhesive therebetween;

wherein the composite material has a three-dimensional, engineered shape prepared from a mold, and wherein the composite material does not include a veil, scrim, or mesh.

42. The composite material of embodiment 40, wherein the polyurethane composite core or the foamed polyurethane composite core is essentially free of fibers.
43. The composite material of embodiment 41 or 42, wherein the composite material can withstand 200 freeze-thaw cycles or more.
44. The composite material of embodiment 41, 42 or 43, wherein the composite material is heat tolerant to 80° C. for at least 24 hours.
45. The composite material of embodiment 41, 42, 43 or 44, wherein the composite material has a flexural strength of from 2.07 MPa or 300 psi to 3.10 MPa or 450 psi.
46. The composite material of embodiment 41, 42, 43, 44 or 45, wherein the composite material has a modulus of from 0.41 MPa or 60 psi to 0.90 MPa or 130 psi.
47. The composite material of embodiment 41, 42, 43, 44, 45 or 46, wherein the polyurethane composite core or the foamed polyurethane composite core is a reaction product of at least one polyol and at least one isocyanate in the presence of the Class C fly ash, and wherein the at least one isocyanate is selected from the group consisting of diisocyanates, polyisocyanates, and combinations thereof.
48. The composite material of embodiment 41, 42, 43, 44, 45, 46 or 47, wherein the shape is a rectangular panel 91.44 cm or 3 ft. in width, 152.4 cm or 5 ft. in length, less than or equal to 2.54 cm or 1 in. thick, and weighs less than 6.80 kg or 15 lbs.
49. The composite material of embodiment 41-48, wherein the lightweight aggregate is foamed glass beads present in an amount of from 2% by weight to 30% by weight based on 100% by weight of the cementitious layer.
50. The composite material of any of embodiments 41-49, wherein the lightweight aggregate is foamed glass beads present in an amount of 5% by weight to 10% by weight based on 100% of the cementitious layer.
51. The composite material of any of embodiments 41-50, wherein the lightweight aggregate is expanded perlite present in an amount of from 0.01% by weight to 5% by weight based on 100% by weight of the cementitious layer.
52. The composite material of any of embodiments 41-52, wherein the lightweight aggregate is expanded perlite present in an amount of 0.7% by weight based on 100% by weight of the cementitious layer.
53. A composite material comprising:

a cementitious layer comprising:
cement in an amount of from 60% by weight to 80% by weight based on 100% by weight of the cementitious layer; and
foamed glass beads in an amount of from 5% by weight to 10% by weight based on 100% by weight of the cementitious layer;
wherein the cement comprises Portland cement, Type I;
wherein the cementitious layer defines a plurality of entrained pores;
wherein the foamed glass beads are disposed within the plurality of entrained pores; and

a polyurethane composite core or a foamed polyurethane composite core having a first planar surface and a second planar surface disposed opposite the first planar surface, wherein the polyurethane composite core or the foamed polyurethane composite core comprises:
Class C fly ash present in an amount of from 40% by weight to 60% by weight based on 100% by weight of the polyurethane composite core or the foamed polyurethane composite core;
wherein the polyurethane composite core or the foamed polyurethane composite core is a reaction product of at least one polyol and at least one isocyanate in the presence of the Class C fly ash, wherein the at least one isocyanate is selected from the group consisting of diisocyanates, polyisocyanates, and combinations thereof;
wherein the cementitious layer and the polyurethane composite core or the foamed polyurethane composite core are in continuous physical communication at the first planar surface and the second planar surface without any adhesive therebetween;

wherein the composite material is a three-dimensional, engineered panel prepared from a mold, wherein the composite material does not include a veil, scrim, or mesh, and wherein the polyurethane composite core or the foamed polyurethane composite core is essentially free of fibers.

54. The composite material of embodiment 53, wherein the cement further comprises Portland cement, Type III; and

wherein the Portland cement, Type I and the Portland cement, Type III are present in a ratio of Portland cement, Type I to Portland cement, Type III of from 1:5 to 5:1, for example 4:1.

55. The composite material of embodiment 52 or 53, wherein the foamed glass beads are present in an amount of less than or equal to 7% by weight based on 100% by weight of the cementitious layer.
56. The composite material of embodiment 53, having a density of 0.29 g/cm³ or 18 pcf to 0.30 g/cm³ or 19 pcf.
57. The composite material of embodiment 53, having a modulus of from 551.58 MPa or 80 ksi to 792.90 MPa or 115 ksi.
58. The composite material of embodiment 53, having a flexural strength of from 2.14 MPa or 310 psi to 3.03 MPa or 440 psi.
59. The composite material of embodiment 53, wherein the composite material can withstand 200 freeze-thaw cycles.
60. The composite material of embodiment 53, wherein the composite material is heat tolerant to 80° C. for at least 24 hours.
61. A composite material comprising:

a cementitious layer comprising:
cement in an amount of from 60% by weight to 80% by weight based on 100% by weight of the cementitious layer; and
expanded perlite in an amount of from 0.1% by weight to 5% by weight based on 100% by weight of the cementitious layer;
wherein the cement comprises Portland cement, Type I;
wherein the cementitious layer defines a plurality of entrained pores;
wherein the expanded perlite is disposed in the plurality of entrained pores; and

a polyurethane composite core or a foamed polyurethane composite core having a first planar surface and a second planar surface disposed opposite the first planar surface, wherein the polyurethane composite core or the foamed polyurethane composite core comprises:
Class C fly ash present in an amount of from 40% by weight to 60% by weight based on 100% by weight of the polyurethane composite core or the foamed polyurethane composite core;
wherein the polyurethane composite core or the foamed polyurethane composite core is a reaction product of at least one polyol and at least one isocyanate selected from the group consisting of diisocyanates, polyisocyanates, and combinations thereof in the presence of the Class C fly ash;
wherein the cementitious layer and the polyurethane composite core or the foamed polyurethane composite core are in continuous physical communication at the first planar surface and the second planar surface without any adhesive therebetween;

wherein the composite material is a three-dimensional, engineered panel prepared from a mold, wherein the composite material does not comprise a veil, scrim, or mesh, and wherein the polyurethane composite core or the foamed polyurethane composite core is essentially free of fibers.

62. The composite material of embodiment 61, wherein the cement further comprises calcium sulfoaluminate cement; and wherein the Portland cement, Type I and the calcium sulfoaluminate cement are present in a ratio of Portland cement, Type I to calcium sulfoaluminate cement of from 1:5 to 5:1, for example 4:1.
63. The composite material of embodiment 61 or 62, wherein the expanded perlite is present in an amount of 0.7% by weight based on 100% by weight of the cementitious layer.
64. The composite material of embodiment 61, having a density of 0.30 g/cm³ or 19 pcf to 0.32 g/cm³ or 20 pcf.
65. The composite material of embodiment 61, having a modulus of from 551.58 MPa or 80 ksi to 620.53 MPa or 90 ksi.
66. The composite material of embodiment 61, having a flexural strength of from 2.14 MPa or 310 psi to 2.48 MPa or 360 psi.
67. The composite material of embodiment 61, wherein the composite material can withstand 200 freeze-thaw cycles.
68. The composite material of embodiment 61, wherein the composite material is heat tolerant to 80° C. for at least 24 hours.
69. The composite material of any of above embodiments 1-68, wherein the polyurethane composite core is based on a polyether- or polyester-based polyol and a diisocyanate or polyisocyanate that includes MDI, PMDI, TDI, or alkyl isocyanates and the polyol can contain an aromatic content and can incorporate a Mannich derived polyol(s).
70. A method of producing a building material formed from the composite material of any above embodiment, the method comprising:

contacting the polyurethane composite core with the cementitious layer; and

curing the cementitious layer to dispose the cementitious layer in physical communication with the polyurethane composite core without disposing an adhesive between the cementitious layer and the polyurethane composite core.

71. The method of embodiment 70, further comprising preparing the cementitious layer by admixing lightweight aggregate with a mixture comprising the cement and water.
72. The method of embodiment 70 or 71, wherein the lightweight aggregate is selected from the group consisting of natural mineral perlite and foamed glass beads; and

wherein the lightweight aggregate is present in an amount of from 2% by weight to 30% by weight based on 100% by weight of the cementitious layer.

73. The method of embodiment 70, 71 or 72, wherein the curing comprises the formation of pores comprising lightweight aggregates disposed therein in the cementitious layer.
74. The method of any of embodiments 70-73, further comprising, prior to contacting, providing the polyurethane composite core and shaping at least the first planar surface.
75. The method of any of embodiments 70-74, wherein the polyurethane composite core has a second planar surface disposed opposite the first planar surface, and further comprising:
prior to contacting, providing the polyurethane composite core; and
shaping the first planar surface and the second planar surface;
wherein contacting includes disposing the cementitious layer on the first planar surface and the second planar surface; and
wherein curing includes forming a continuous cementitious layer in physical communication with the first planar surface and the second planar surface.
   76. The method of any of embodiments 70-75, wherein admixing comprises:

high-shear mixing the cement and water to form the mixture; and

after high-shear mixing, low-shear mixing the lightweight aggregate and the mixture to form the cementitious layer.

77. A composite material comprising:

a cementitious layer comprising cement, wherein the cement comprises at least one of pores, a lightweight aggregate, or both; and

a polyurethane composite core having at least one surface, the polyurethane composite core comprising a polymer and a filler,

wherein the cementitious layer is in physical communication with the at least one surface.

78. The composite material of embodiment 76, wherein the cementitious layer comprises cement in an amount of greater than or equal to 10% by weight based on 100% by weight of the cementitious layer, and wherein the polyurethane composite core comprises polyurethane, and wherein the polyurethane composite core comprises fly ash in an amount of from 35% by weight to 80% by weight based on 100% by weight of the polyurethane composite core.
79. A method for improving a property of a composite material, the method comprising:

providing at least one of pores, a lightweight aggregate, or both in a cementitious layer,

wherein the composite material comprises the cementitious layer and a polyurethane composite core having at least one surface, the polyurethane composite core comprising a polymer and a filler;

wherein the cementitious layer is in physical communication with the at least one surface, and

wherein the property is selected from the group consisting of a weather-resistance property, flexural property, tensile property, rigidity, toughness, hardness, optical appearance, water resistance, resilience in the presence of electromagnetic radiation, and combinations thereof.

80. The method of embodiment 80, wherein the cementitious layer comprises cement in an amount of greater than or equal to 10% by weight based on 100% by weight of the cementitious layer, and wherein the polymer comprises polyurethane, and wherein the polyurethane composite core comprises fly ash in an amount of from 35% by weight to 80% by weight based on 100% by weight of the polyurethane composite core.

The following examples are offered by way of illustration and not by way of limitation.

### EXAMPLES

### Example 1. Composite Material

A composite material is prepared having a polyurethane composite core and a single cementitious layer disposed in physical communication with two planar surfaces of the polyurethane composite core.

The polyurethane composite core is prepared in a mold. The polyurethane composite core is formed from polyol and isocyanate reactants and includes 50% by weight of a Class C fly ash filler based on 100% by weight of the polyurethane composite core. The polyurethane composite core is blown with water in the presence of surfactants and catalysts to achieve a density of greater than 0.16 g/cm³ or 10 pcf, but no greater than 0.32 g/cm³ or 20 pcf. In general, the density is from 0.18 g/cm³ or 11 pcf to 0.19 g/cm³ or 12 pcf, occasionally 0.26 g/cm³ or 16 pcf. In Example 1, the density of the polyurethane composite core is 0.19 g/cm³ or 11.8 pcf. The reactants are contacted and a reaction mixture is cast into the mold. The reactants are allowed to cure in the mold at ambient conditions for 24 hours to form the polyurethane composite core, which is removed from the mold.

The polyurethane composite core is cut using a band saw to desired dimensions such that including the cementitious layer(s), the final product has the desired dimensions. In this Example, the final product is a rectangular panel that is 30.48 cm or 1 ft. wide, 45.72 cm or 1.5 ft. long, and 1.27 cm or ½ in. thick.

A cementitious layer is prepared. The cement, water, a viscosity modifying admixture, and fiberglass are mixed at high shear for 5 minutes. The mix speed is then reduced and immediately a superplasticizer and lightweight aggregate is added. The mix continues at low shear for 1 minute.

The cured and dimensioned polyurethane composite core is contacted with the cementitious layer. Freshly mixed cementitious layer is placed on one planar surface of the polyurethane composite core. The cementitious layer is spread evenly over the planar surface using a trowel. Care is taken not to permit segregation of ingredients within the cementitious layer and to apply a reasonably consistent layer with respect to thickness. The freshly coated planar surface is placed face down on a stand with a few contact points so as not to mar the coated uncured surface. The procedure of coating is repeated to the opposite planar surface of the polyurethane composite core. This composite material is stored at room temperature for from 18 hours to 24 hours to allow curing of the cementitious layer. After curing, the composite material consists of a cured and dimensioned polyurethane composite core and a double-sided, cementitious layer disposed on both planar surfaces of the polyurethane composite core.

FIG. 1 is a depiction of the composite material prepared according to this Example.

### Example 2. Composite Material Characteristics

Three composite materials (Composite Materials 1, 2, and 3) prepared according to Example 1 have the following properties. The polyurethane composite core of Composite Material 1 has a density of 0.19 g/cm³. Upon coating both planar surfaces with the cementitious layer, the density increases to 0.32 g/cm³. The flexural strength of the composite material is 2.52 MPa or 365 psi, which is 1.24 MPa or 180 psi higher than the flexural strength of the polyurethane composite core due to the cementitious layer. The modulus of Composite Material 1 is 758.42 MPa or 110 ksi, which is 0.66 MPa or 96 psi higher than the modulus of the polyurethane composite core due to the cementitious layer. The cementitious layer adds 0.13 g/cm³ of density to Composite Material 1.

The polyurethane composite core of Composite Material 2 has a density of 0.25 g/cm³. Upon coating both planar surfaces with the cementitious layer, the density increases to 0.33 g/cm³, which is similar to the density of Composite Material 1 (0.32 g/cm³). The flexural strength of Composite Material 2 is 3.11 MPa or 451 psi, which is 1.02 MPa or 148 psi higher than the flexural strength of the polyurethane composite core due to the cementitious layer. The modulus of Composite Material 2 is 827.37 MPa or 120 ksi, which is 0.70 MPa or 102 psi higher than the modulus of the polyurethane composite core due to the cementitious layer. The cementitious layer adds 0.08 g/cm³ of density to Composite Material 2. Compared to Composite Material 1, the polyurethane composite core density of Composite Material 2 is higher and requires more polyurethane. The flexural strength and modulus of Composite Material 1 is 2.52 MPa or 365 psi and 758.42 MPa or 110 ksi respectively, which is lower than the flexural strength and modulus of Composite Material 2.

A high polyurethane composite core density requires more polyurethane compared to a lower density polyurethane composite core. Polyurethane components are relatively more expensive than cementitious components. However, while it is desirous to use the least amount of polyurethane and the greatest amount of cement, doing so requires certain considerations as described herein. The intrinsic density of foamed polyurethane can be maintained below 0.33 g/cm³, while the density of a cementitious layer is generally between 0.90 and 1.20 g/cm³. Thus, to provide the least cost and lowest density, it is desirable to reduce the polyurethane composite core component weight and balance the amount of cementitious layer weight to obtain a desired composite material weight. However, a comparison of Composite Materials 1 and 2 shows that the reduction in density of the polyurethane composite core and the increase in amount of cementitious layer to reduce the cost of the Composite Materials compromises the properties of the Composite Materials.

The polyurethane composite core of Composite Material 3 has a density of 0.19 g/cm³, which is very similar to the polyurethane composite core of Composite Material 1. Upon coating both planar surfaces with a cementitious layer as described above, the density of Composite Material 3 increases to 0.28 g/cm³, which is lower than the density of Composite Material 1 (0.32 g/cm³) and Composite Material 2 (0.33 g/cm³). The flexural strength of Composite Material 3 is 2.12 MPa or 319 psi, which is 0.73 MPa or 106 psi higher than the density of the polyurethane composite core due to the cementitious layer. The modulus of Composite Material 3 is 537.79 MPa or 78 ksi, which is 0.43 MPa or 63 psi higher than the modulus of the polyurethane composite core due to the cementitious layer. The cementitious layer adds 0.09 g/cm³ of density to Composite Material 3. Compared to Composite Material 2, the polyurethane composite core density of Composite Material 3 is similar and both Composite Materials require similar amounts of polyurethane. The flexural strength and modulus of Composite Material 3 is 2.20 MPa or 319 psi and 730.84 MPa or 106 ksi respectively, which is lower than the flexural strengths and moduli of Composite Material 1 or Composite Material 2. Thus, the reduction in density of the polyurethane composite core and increase or decrease in an amount of cementitious layer to reduce the weight and cost of Composite Material 3 compromises the properties of Composite Material 3.

### Example 3. Air Entraining Agents to Modulate Flexural Strength and Modulus

Composite Materials are prepared following the protocol of Example 1; however, the cementitious layer is prepared to define pores of air via air-entrainment using sodium 2-ethylhexyl sulfate, available as Witcolate™ D-510 in Composite Materials 4 through 6, and the use of dodecyl sulfonic acid, available as Witconate™ AOS12 from AkzoNobel Industries, in Composite Materials 7 through 9. The density of the Composite Material after coating is maintained between 0.34 g/cm³ and 0.31 g/cm³ in Composite Materials 4 through 6 so as to either be greater than, equal to, or less than the density of Composite Material 1. When Composite Materials 4 through 6 are compared to Composite Material 1, the presence or absence of air entrainer at similar weight of the Composite Material provides similar flexural strength and modulus.

Composite Materials 7 through 9 investigate reduced weight of the Composite Material using air entraining agents in the cementitious layer. The density of the polyurethane composite core is the same at 0.19 g/cm³ in Composite Materials 7 through 9 as compared to Composite Materials 1 and 3. The density of the Composite Material after coating is progressively reduced from 0.29 to 0.28 to 0.27 in Composite Materials 7 through 9 so as to either be greater than, equal to, or less than Composite Material 3. When Composite Materials 7 through 9 are compared to Composite Material 3, the addition of air entrainer to reduce the weight of the Composite Material decreases the flexural strength and reduces the modulus. This evidence indicates that the creation or definition of entrained pores within a Composite Material is detrimental to the mechanical properties of the Composite Material and is not a useful method of decreasing weight and lowering cost of a panel formed from the Composite Material.

### Example 4. Lightweight Aggregates Modulate Flexural Strength and Modulus

Composite Materials are prepared following the protocol of Example 1; however, the cementitious layer is prepared to define entrained pores having lightweight aggregates contained therein.

The impact of inclusion of entrained pores having lightweight aggregates therein is tested. The lightweight aggregates are derived from expanded natural mineral perlite, referred to as “expanded perlite” manufactured, and derived from manufactured foamed glass beads.

Table 1 summarizes data for the following: Control (cementitious material without pores and without lightweight aggregates therein); Composite Material (Composite Materials 13 through 16) defining entrained pores containing expanded perlite therein; and Composite Material (Composite Materials 10 through 12 and 17 through 19) defining entrained pores containing foamed glass beads therein. As illustrated by the data, inclusion of expanded perlite and foamed glass beads in Composite Materials 10 through 19 provides a cementitious layer with a lower density when compared to a cementitious layer that does not include the lightweight aggregates, while maintaining adequate flexural strength and modulus for building material applications.

The density of Composite Materials 10 through 12 are 6% lower to 10% lower than the control sample of Composite Material 1. Composite Materials 10 through 12 that include foamed glass beads in amounts of 2% by weight, 5% by weight, and 10% by weight of the cementitious layer provide flexural strength equal to or higher than the control sample of Composite Material 1. The density of Composite Materials 17 through 19 is closer to the density of Composite Material 1 except for the use of 10% by weight foamed glass beads in Composite Material 19. The improvement in flexural properties and modulus in Composite Materials 10 through 12 evidence a lower density compared to Composite Material 1, yet achieve the same mechanical properties. However, that is not the case in Composite Materials 17 through 19. Data for Composite Materials 1-19 are presented in Table 1.

TABLE 1

| Composite | | | | | | | | | | |
|---|---|---|---|---|---|---|---|---|---|---|
| Material No. | 1 | 2 | 3 | 4 | 5 | 6 | 7 | 8 | 9 | 10 |
| Ordinary Portland | 400 | 400 | 400 | 400 | 400 | 400 | 400 | 400 | 400 | 400 |
| Cement Type I/II, | | | | | | | | | | |
| g | | | | | | | | | | |
| CSA Cement, g | 100 | 100 | 100 | 100 | 100 | 100 | 100 | 100 | 100 | 100 |
| Water, g | 200 | 200 | 200 | 200 | 200 | 200 | 200 | 200 | 200 | 200 |
| Hydroxypropyl | 1.25 | 1.25 | 1.25 | 1.25 | 1.25 | 1.25 | 1.25 | 1.25 | 1.25 | 1.25 |
| methylcellulose, g | | | | | | | | | | |
| Polycarboxylate | 1.50 | 1.50 | 1.50 | 1.50 | 1.50 | 1.50 | 1.50 | 1.50 | 1.50 | 1.50 |
| Superplasticizer, g | | | | | | | | | | |
| Chopped DE | 5 | 5 | 5 | 5 | 5 | 5 | 5 | 5 | 5 | 5 |
| Fiberglass 1/4″ | | | | | | | | | | |
| length, g | | | | | | | | | | |
| Foamed Glass | 0 | 0 | 0 | 0 | 0 | 0 | 0 | 0 | 0 | 10 |
| Beads 0.1-0.3 mm, | | | | | | | | | | |
| g | | | | | | | | | | |
| Foamed Glass | 0 | 0 | 0 | 0 | 0 | 0 | 0 | 0 | 0 | 0 |
| Beads 0.25- | | | | | | | | | | |
| 0.5 mm, g | | | | | | | | | | |
| Expanded Perlite, | 0 | 0 | 0 | 0 | 0 | 0 | 0 | 0 | 0 | 0 |
| 0.05 to 0.3 mm | | | | | | | | | | |
| size | | | | | | | | | | |
| Expanded Perlite | 0 | 0 | 0 | 0 | 0 | 0 | 0 | 0 | 0 | 0 |
| 0.2 to 0.5 mm size | | | | | | | | | | |
| Dodecyl Sulfonic | 0 | 0 | 0 | 0 | 0 | 0 | 0.3 | 0.38 | 0.5 | 0 |
| Acid, g | | | | | | | | | | |
| Sodium 2- | 0 | 0 | 0 | 0.3 | 0.38 | 0.5 | 0 | 0 | 0 | 0 |
| Ethylhexyl | | | | | | | | | | |
| Sulfate, g | | | | | | | | | | |
| Density of | 0.19 | 0.25 | 0.19 | 0.19 | 0.19 | 0.19 | 0.19 | 0.19 | 0.19 | 0.20 |
| Polyurethane | | | | | | | | | | |
| Composite Core, | | | | | | | | | | |
| g/cm³ | | | | | | | | | | |
| Density of Coated | 0.32 | 0.33 | 0.28 | 0.34 | 0.31 | 0.32 | 0.29 | 0.28 | 0.27 | 0.30 |
| Polyurethane | | | | | | | | | | |
| Composite Core, | | | | | | | | | | |
| g/cm³ | | | | | | | | | | |
| Density | 0 | N/A | N/A | −8 | −29 | 3 | −36 | −51 | −59 | −20 |
| Increase/Thickness | | | | | | | | | | |
| Increase | | | | | | | | | | |
| Compared to | | | | | | | | | | |
| Example 2, % | | | | | | | | | | |
| Flexural Strength | 365 | 451 | 319 | 396 | 338 | 386 | 324 | 295 | 266 | 432 |
| of Coated | | | | | | | | | | |
| Polyurethane | | | | | | | | | | |
| Composite Core, | | | | | | | | | | |
| psi | | | | | | | | | | |
| Flexural Strength | 2.52 | 3.11 | 2.20 | 2.73 | 2.33 | 2.66 | 2.23 | 2.04 | 1.83 | 2.98 |
| of Coated | | | | | | | | | | |
| Polyurethane | | | | | | | | | | |
| Composite Core, | | | | | | | | | | |
| MPa | | | | | | | | | | |
| Flexural Strength | 180 | 148 | 106 | 173 | 116 | 163 | 102 | 72 | 43 | 212 |
| Increase of Coated | | | | | | | | | | |
| Polyurethane | | | | | | | | | | |
| Composite Core | | | | | | | | | | |
| due to | | | | | | | | | | |
| Cementitious | | | | | | | | | | |
| Layer, psi | | | | | | | | | | |
| Flexural Strength | 1.24 | 1.02 | 0.73 | 1.19 | 0.80 | 1.12 | 0.70 | 0.50 | 0.30 | 1.46 |
| Increase of Coated | | | | | | | | | | |
| Polyurethane | | | | | | | | | | |
| Composite Core | | | | | | | | | | |
| due to | | | | | | | | | | |
| Cementitious | | | | | | | | | | |
| Layer, MPa | | | | | | | | | | |
| Modulus of | 110 | 120 | 78 | 104 | 84 | 115 | 77 | 63 | 55 | 123 |
| Coated | | | | | | | | | | |
| Polyurethane | | | | | | | | | | |
| Composite Core, | | | | | | | | | | |
| ksi | | | | | | | | | | |
| Modulus of | 758.42 | 827.37 | 537.79 | 717.05 | 579.16 | 792.90 | 530.90 | 434.37 | 379.21 | 848.06 |
| Coated | | | | | | | | | | |
| Polyurethane | | | | | | | | | | |
| Composite Core, | | | | | | | | | | |
| MPa | | | | | | | | | | |
| Modulus Increase | 96 | 102 | 63 | 89 | 68 | 99 | 61 | 47 | 39 | 108 |
| of Coated | | | | | | | | | | |
| Polyurethane | | | | | | | | | | |
| Composite Core | | | | | | | | | | |
| due to | | | | | | | | | | |
| Cementitious | | | | | | | | | | |
| Layer, ksi | | | | | | | | | | |
| Modulus Increase | 661.90 | 703.27 | 434.37 | 613.63 | 468.84 | 682.58 | 420.58 | 324.05 | 268.90 | 744.63 |
| of Coated | | | | | | | | | | |
| Polyurethane | | | | | | | | | | |
| Composite Core | | | | | | | | | | |
| due to | | | | | | | | | | |
| Cementitious | | | | | | | | | | |
| Layer, MPa | | | | | | | | | | |
| Cycles Freeze- | 25 | 25 | 25 | 50 | 50 | 50 | 50 | 50 | 50 | 200 |
| Thaw Before | | | | | | | | | | |
| Failure of Coated | | | | | | | | | | |
| Polyurethane | | | | | | | | | | |
| Composite Core, # | | | | | | | | | | |
| Temperature until | 50 | 50 | 50 | 50 | 50 | 50 | 50 | 50 | 50 | 80 |
| Heat Cracking of | | | | | | | | | | |
| Coated | | | | | | | | | | |
| Polyurethane | | | | | | | | | | |
| Composite Core, | | | | | | | | | | |
| ° C. | | | | | | | | | | |

| Composite | | | | | | | | | |
|---|---|---|---|---|---|---|---|---|---|
| Material No. | 11 | 12 | 13 | 14 | 15 | 16 | 17 | 18 | 19 |
| Ordinary Portland | 400 | 400 | 400 | 400 | 400 | 400 | 400 | 400 | 400 |
| Cement Type I/II, | | | | | | | | | |
| g | | | | | | | | | |
| CSA Cement, g | 100 | 100 | 100 | 100 | 100 | 100 | 100 | 100 | 100 |
| Water, g | 200 | 200 | 200 | 200 | 200 | 200 | 200 | 200 | 200 |
| Hydroxypropyl | 1.25 | 1.25 | 1.3 | 1.3 | 1.3 | 1.3 | 1.25 | 1.25 | 1.25 |
| methylcellulose, g | | | | | | | | | |
| Polycarboxylate | 1.50 | 1.50 | 1.5 | 1.5 | 1.5 | 1.5 | 1.50 | 1.50 | 1.50 |
| Superplasticizer, g | | | | | | | | | |
| Chopped DE | 5 | 5 | 5 | 5 | 5 | 5 | 5 | 5 | 5 |
| Fiberglass 1/4″ | | | | | | | | | |
| length, g | | | | | | | | | |
| Foamed Glass | 25 | 50 | 0 | 0 | 0 | 0 | 0 | 0 | 0 |
| Bead 0.1-0.3 mm, | | | | | | | | | |
| g | | | | | | | | | |
| Foamed Glass | 0 | 0 | 0 | 0 | 0 | 0 | 10 | 25 | 50 |
| Bead 0.25-0.5 | | | | | | | | | |
| mm, g | | | | | | | | | |
| Expanded Perlite, | 0 | 0 | 5 | 10 | 0 | 0 | 0 | 0 | 0 |
| 0.05 to 0.3 mm | | | | | | | | | |
| size | | | | | | | | | |
| Expanded Perlite, | 0 | 0 | 0 | 0 | 5 | 10 | 0 | 0 | 0 |
| 0.2 to 0.5 mm size | | | | | | | | | |
| Dodecyl Sulfonic | 0 | 0 | 0 | 0 | 0 | 0 | 0 | 0 | 0 |
| Acid, g | | | | | | | | | |
| Sodium 2- | 0 | 0 | 0 | 0 | 0 | 0 | 0 | 0 | 0 |
| Ethylhexyl | | | | | | | | | |
| Sulfate, g | | | | | | | | | |
| Density of | 0.20 | 0.19 | 0.20 | 0.20 | 0.20 | 0.20 | 0.19 | 0.19 | 0.19 |
| Polyurethane | | | | | | | | | |
| Composite Core, | | | | | | | | | |
| g/cm³ | | | | | | | | | |
| Density of | 0.29 | 0.29 | 0.29 | 0.30 | 0.32 | 0.34 | 0.32 | 0.31 | 0.30 |
| Polyurethane | | | | | | | | | |
| Composite Coated | | | | | | | | | |
| Core, g/cm³ | | | | | | | | | |
| Density | −30 | −31 | −31 | −34 | −33 | −33 | −24 | −32 | −43 |
| Increase/Thickness | | | | | | | | | |
| Increase | | | | | | | | | |
| Compared to | | | | | | | | | |
| Example 2, % | | | | | | | | | |
| Flexural Strength | 404 | 368 | 355 | 320 | 348 | 312 | 367 | 364 | 318 |
| of Coated | | | | | | | | | |
| Polyurethane | | | | | | | | | |
| Composite Core, | | | | | | | | | |
| psi | | | | | | | | | |
| Flexural Strength | 2.79 | 2.54 | 2.45 | 2.21 | 2.40 | 2.15 | 2.53 | 2.51 | 2.19 |
| of Coated | | | | | | | | | |
| Polyurethane | | | | | | | | | |
| Composite Core, | | | | | | | | | |
| MPa | | | | | | | | | |
| Flexural Strength | 184 | 147 | 134 | 100 | 128 | 91 | 147 | 144 | 97 |
| Increase of | | | | | | | | | |
| Polyurethane | | | | | | | | | |
| Composite Coated | | | | | | | | | |
| Core due to | | | | | | | | | |
| Cementitious | | | | | | | | | |
| Layer, psi | | | | | | | | | |
| Flexural Strength | 1.27 | 1.01 | 0.92 | 0.69 | 0.88 | 0.63 | 1.01 | 0.99 | 0.67 |
| Increase of Coated | | | | | | | | | |
| Polyurethane | | | | | | | | | |
| Composite Core | | | | | | | | | |
| due to | | | | | | | | | |
| Cementitious | | | | | | | | | |
| Layer, MPa | | | | | | | | | |
| Modulus of | 115 | 93 | 89 | 88 | 86 | 81 | 98 | 96 | 81 |
| Coated | | | | | | | | | |
| Polyurethane | | | | | | | | | |
| Composite Core, | | | | | | | | | |
| ksi | | | | | | | | | |
| Modulus of | 792.90 | 641.21 | 613.63 | 606.74 | 592.95 | 558.48 | 675.69 | 661.90 | 558.48 |
| Coated | | | | | | | | | |
| Polyurethane | | | | | | | | | |
| Composite Core, | | | | | | | | | |
| MPa | | | | | | | | | |
| Modulus Increase | 99 | 78 | 74 | 73 | 71 | 66 | 82 | 81 | 66 |
| of Coated | | | | | | | | | |
| Polyurethane | | | | | | | | | |
| Composite Core | | | | | | | | | |
| due to | | | | | | | | | |
| Cementitious | | | | | | | | | |
| Layer, ksi | | | | | | | | | |
| Modulus Increase | 682.58 | 537.79 | 510.21 | 503.32 | 489.53 | 455.05 | 565.37 | 558.48 | 455.05 |
| of Coated | | | | | | | | | |
| Polyurethane | | | | | | | | | |
| Composite Core | | | | | | | | | |
| due to | | | | | | | | | |
| Cementitious | | | | | | | | | |
| Layer, MPa | | | | | | | | | |
| Cycles Freeze- | 200 | 200 | 200 | 200 | 200 | 200 | 200 | 200 | 200 |
| Thaw Before | | | | | | | | | |
| Failure of Coated | | | | | | | | | |
| Polyurethane | | | | | | | | | |
| Composite Core, # | | | | | | | | | |
| Temperature until | 80 | 80 | 70 | 70 | 70 | 70 | 80 | 80 | 80 |
| Heat Cracking of | | | | | | | | | |
| Coated | | | | | | | | | |
| Polyurethane | | | | | | | | | |
| Composite Core, | | | | | | | | | |
| ° C. | | | | | | | | | |

Density of the Composite Material is tested by weighing the Composite Material and reporting the weight per unit volume. The flexural strength is the load required to fracture a rectangular prism loaded in the three point bend test described in ASTM C1185. The modulus is calculated as the slope of the stress/strain curve from the three point bend test.

### Example 5. Durability Determination: Freeze/Thaw Analysis

To test the durability of the Composite Materials, including resistance to deterioration, cracking, peeling, and surface bond adhesion, a “surface freeze/thaw” test is used. To ensure penetration of water into the Composite Material, the surface (the entirety of the cementitious layer on one side of the Composite Material, plus 0.64 cm or ¼ inches to 1.27 cm or ½ inches of the adhered polyurethane composite core) is submerged in water. The submerged Composite Material is subjected to cycles of 3 hours of freezing at −10° C., followed by 1 hour of thawing at temperatures up to 10° C., until failure is observed. To determine failure, samples are periodically removed from the cycling and visually inspected for degradation and structural integrity. Failure is determined as visible indications of cracking, fissures, peeling, sponginess, etc.

Table 2 summarizes the number of cycles for freeze-thaw testing for the following Composite Materials: Composite Material with a cementitious material (without pores and without lightweight aggregates disposed therein); Composite Material with a cementitious layer having entrained air (but without pores and without lightweight aggregates disposed therein); Composite Material defining entrained pores and containing 20% foamed glass beads (based on 100% by weight of the cementitious layer) therein; Composite Material defining entrained pores and containing 4% expanded perlite (based on 100% by weight of the cementitious layer) therein. As illustrated by the data, inclusion of lightweight aggregates such as expanded perlite and foamed glass beads provides a cementitious layer with substantially longer durability in freeze-thaw testing.

TABLE 2

| Coating Type of the Composite Material | # of cycles until failure |
|---|---|
| No coat Modification | 25-50 |
| 6%-11% by coating weight entrained air | 50 |
| 20% by cementitious layer weight addition | 150+ |
| of foamed glass beads | |
| 4% by cementitious layer weight addition | 150+ |
| of expanded perlite | |

The data in Table 1 for Composite Materials 10 through 12 summarize an improvement of the freeze thaw behavior compared to the control sample of Composite Material 1.

The results of surface freeze/thaw testing on samples with no modification of the coating (no pores or entrained air and no lightweight aggregates) is compared to samples with air or lightweight aggregates in the cementitious layer. The inclusion of lightweight aggregates provides a Composite Material that withstands three times or more the number of cycles of freezing and thawing.

The surface freeze/thaw test also determines whether entrained air alone or pores having lightweight aggregates contained therein provide substantially different properties. The use of air voids is contemplated as free space for ice expansion. However, during the surface freeze/thaw testing, the Composite Material survived 50 cycles before failure. A composite material having an unmodified cementitious layer can fail as early as 25 cycles. Compared to entrained air voids and the no-modification sample, the lightweight aggregates provide three times the durability during the freeze-thaw testing.

Free spaces in air voids may provide room for expansion, but the data show the effect can be substantially improved. Each air void is a potential site for failure due to deterioration or cracking at, near, or within the void. Without being bound by theory, the entrained pores having lightweight aggregates disposed therein provide an internal air pore system for water movement during freeze/thaw cycles, and also provide structural support with solid struts. In addition, the compatibility between cementitious matrix of the cementitious layer and the surface of the lightweight aggregates creates a strong bond between the two materials and further reinforces the structure. As a result, in embodiments, inclusion of lightweight aggregates in the cementitious layer of the Composite Materials described herein improves the freeze/thaw resistance by more than three times.

### Example 6. Durability Determination: Heat Cracking Analysis

To test durability against heat cracking, the Composite Materials are tested at elevated temperature for long durations of time. The Composite Materials are placed into a series of ovens having increasing temperature. Measurements are taken for temperature and time points where cracking became visible to the eye. Samples are kept in an oven for a week at each temperature level, although cracks typically occur within the first 24 hours.

The data for the Composite Materials listed in Table 1 show that entrained air does not provide a benefit in the ability of the cementitious layer to resist cracking at elevated temperature conditions. Lightweight aggregate significantly increases the durability of the cementitious layer at elevated temperature conditions with respect to cracks on the surface. While not being bound by theory, the lightweight aggregate may act as a barrier to moisture movement, may trap water inside the cementitious layer, may act as a heat sink, and may alleviate the temperature stress on the cementitious layer.

As used herein, the term “a” or “an” entity refers to one or more of that entity; for example, “a nanoparticle” is understood to represent one or more nanoparticles. As such, the terms “a” (or “an”), “one or more,” and “at least one” can be used interchangeably herein.

Throughout this specification and the claims, the words “comprise,” “comprises,” and “comprising” are used herein synonymously with the term “including” and are used in a non-exclusive sense and except where the context requires otherwise. “Comprising” and the like are intended to mean that the compositions and methods include the recited elements, but does not exclude others. “Consisting essentially of” when used to define compositions and methods, shall mean excluding other elements of any essential significance to the combination for the stated purpose. Thus, a composition consisting essentially of the elements as defined herein would not exclude other materials that do not materially affect the basic and novel characteristic(s) of the claimed composition. A method consisting essentially of the steps as defined herein would not exclude other steps that do not materially affect the basic and novel characteristic(s) of the claimed method. “Consisting of” shall mean excluding more than trace elements of other ingredients and substantial method steps. Embodiments defined by each of these transition terms are within the scope of the subject matter described herein.

As used herein, “optional” or “optionally” means that the subsequently described event or circumstance can or cannot occur, and that the description includes instances where the event or circumstance occurs and instances where it does not.

Also as used herein, “and/or” refers to and encompasses any and all possible combinations of one or more of the associated listed items, as well as the lack of combinations when interpreted in the alternative (“or”).

All numerical designations, e.g., temperature, time, pressure, force, and concentration, including ranges, are approximations which are varied (+) or (−) by increments of 0.1 or 1.0, where appropriate. It is to be understood, although not always explicitly stated that all numerical designations are preceded by the term “about.” It also is to be understood, although not always explicitly stated, that the reagents described herein are merely exemplary and that equivalents of such are intended.

As used herein, unless otherwise specifically described, the terms “increase,” “increases,” “increased,” “increasing,” “improve,” “enhance,” and similar terms indicate an elevation in the specified parameter of at least about 5%, 10%, 15%, 20%, 25%, 30%, 35%, 40%, 45%, 50%, 55%, 60%, 65%, 70%, 75%, 80%, 85%, 90%, 95%, 100%, 150%, 200%, 300%, 400%, 500% or more.

As used herein, unless otherwise specifically described, the terms “reduce,” “reduces,” “reduced,” “reduction,” and similar terms refer to a decrease in the specified parameter of at least about 5%, 10%, 15%, 20%, 25%, 30%, 35%, 40%, 45%, 50%, 55%, 60%, 65%, 70%, 75%, 80%, 85%, 90%, 95%, 97%, or 100%.

Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the presently disclosed subject matter be limited to the specific values recited when defining a range.

All publications and patent applications mentioned in the specification are indicative of the level of those skilled in the art to which the subject matter described herein pertains. All publications and patent applications are herein incorporated by reference to the same extent as if each individual publication or patent application is specifically and individually indicated to be incorporated by reference.

Many modifications and other embodiments of the subject matter set forth herein will come to mind to one skilled in the art to which this subject matter pertains having the benefit of the teachings presented in the foregoing descriptions and the associated drawings. Therefore, it is to be understood that the subject matter described herein is not to be limited to the specific embodiments disclosed and that modifications and other embodiments are intended to be included within the scope of the foregoing list of embodiments and appended claims. Although specific terms are employed herein, they are used in a generic and descriptive sense only and not for purposes of limitation.

1. A composite material comprising:
a cementitious layer comprising cement in an amount of greater than or equal to 60% by weight based on 100% by weight of the cementitious layer; and
a polyurethane composite core having a first planar surface, wherein the polyurethane composite core comprises fly ash in an amount of from 35% by weight to 80% by weight based on 100% by weight of the polyurethane composite core;
wherein the cementitious layer is in physical communication with the first planar surface.

2-19. (canceled)

20. The composite material of claim 1, further comprising a lightweight aggregate;
wherein the cementitious layer defines a plurality of entrained pores therein that are water absorptive; and
wherein the lightweight aggregate is disposed in the plurality of entrained pores.

21. The composite material of claim 20, wherein two or more of the plurality of entrained pores interconnect to form a network.

22. The composite material of claim 20, wherein the lightweight aggregate is selected from the group consisting of natural mineral perlite, expanded perlite, hollow glass beads, foamed glass beads, ground silica sand, amorphous silica, diatomaceous earth, rice hull ash, blast furnace slag, granulated slag, steel slag, mineral oxides, mineral hydroxides, clays, magnasite, dolomite, layeric beads, volcanic tuff, pumice, ground tire rubber, metal oxides and hydroxides, and combinations thereof.

23. The composite material of claim 20, wherein the lightweight aggregate is selected from the group consisting of expanded natural mineral perlite and foamed glass beads.

24. The composite material of claim 22, wherein the lightweight aggregate is present in an amount of from 0.1% by weight to 30% by weight based on 100% by weight of the cementitious layer.

25. The composite material of claim 22, wherein the lightweight aggregate is present in an amount of from 0.1% by weight to 10% by weight based on 100% by weight of the cementitious layer.

26. The composite material of claim 20, wherein the composite material does not crack after greater than or equal to 50 freeze-thaw cycles in which water penetrates the plurality of entrained pores, is first frozen to and maintained at a temperature of −10° C. for 3 hours, and is subsequently thawed to and maintained at a temperature of 10° C. for 1 hour.

27-37. (canceled)

38. A composite material comprising:
a cementitious layer comprising cement in an amount of from 60% by weight to 80% by weight based on 100% by weight of the cementitious layer;
wherein the cement is a blend of Portland cement, Type I and Portland cement, Type III and is present in a ratio of Portland cement, Type I to Portland cement, Type III of from 1:5 to 5:1; and
wherein the cementitious layer defines a plurality of entrained pores;
a lightweight aggregate disposed in the plurality of entrained pores;
wherein the lightweight aggregate is selected from the group consisting of foamed glass beads, natural mineral perlite, and combinations thereof and is present in an amount of from 0.1% by weight to 10% by weight based on 100% by weight of the cementitious layer; and
a polyurethane composite core or a foamed polyurethane composite core having a first planar surface and a second planar surface disposed opposite the first planar surface, wherein the polyurethane composite core or the foamed polyurethane composite core comprises:
Class C fly ash present in an amount of from 40% by weight to 60% by weight based on 100% by weight of the polyurethane composite core or the foamed polyurethane composite core;
wherein the composite material has a density of from 0.16 g/cm³ to 0.32 g/cm³;
wherein the cementitious layer and the polyurethane composite core or the foamed polyurethane composite core are in continuous physical communication at the first planar surface and the second planar surface without any adhesive therebetween;
wherein the composite material has a three-dimensional, engineered shape prepared from a mold; and
wherein the composite material does not include a veil, scrim, or mesh.

39. The composite material of claim 38, wherein the polyurethane composite core or the foamed polyurethane composite core is essentially free of fibers.

40. The composite material of claim 38, wherein the polyurethane composite core or the foamed polyurethane composite core is a reaction product of at least one polyol and at least one isocyanate in the presence of the Class C fly ash, and wherein the at least one isocyanate is selected from the group consisting of diisocyanates, polyisocyanates, and combinations thereof.

41. A composite material comprising:
a cementitious layer comprising:
cement in an amount of from 60% by weight to 80% by weight based on 100% by weight of the cementitious layer; and
foamed glass beads in an amount of from 5% by weight to 10% by weight based on 100% by weight of the cementitious layer;
wherein the cement comprises Portland cement, Type I;
wherein the cementitious layer defines a plurality of entrained pores; and
wherein the foamed glass beads are disposed within the plurality of entrained pores; and
a polyurethane composite core or a foamed polyurethane composite core having a first planar surface and a second planar surface disposed opposite the first planar surface, wherein the polyurethane composite core or the foamed polyurethane composite core comprises:
Class C fly ash present in an amount of from 40% by weight to 60% by weight based on 100% by weight of the polyurethane composite core or the foamed polyurethane composite core;
wherein the polyurethane composite core or the foamed polyurethane composite core is a reaction product of at least one polyol and at least one isocyanate in the presence of the Class C fly ash, wherein the at least one isocyanate is selected from the group consisting of diisocyanates, polyisocyanates, and combinations thereof;
wherein the cementitious layer and the polyurethane composite core or the foamed polyurethane composite core are in continuous physical communication at the first planar surface and the second planar surface without any adhesive therebetween;
wherein the composite material is a three-dimensional, engineered panel prepared from a mold;
wherein the composite material does not include a veil, scrim, or mesh; and
wherein the polyurethane composite core or the foamed polyurethane composite core is essentially free of fibers.

42. The composite material of claim 41, wherein the cement further comprises Portland cement, Type III; and wherein the Portland cement, Type I and the Portland cement, Type III are present in a ratio of Portland cement, Type I to Portland cement, Type III of from 1:5 to 5:1.

43. The composite material of claim 41, wherein the foamed glass beads are present in an amount of less than or equal to 7% by weight based on 100% by weight of the cementitious layer.

44-52. (canceled)
